(19) United States
(12) Patent Application Publication
(10) Pub. No.: US 2026/0089631 A1
(43) Pub. Date: Mar. 26, 2026

(54) DISCONTINUOUS RECEPTION CYCLES FOR LOW-POWER WAKEUP SIGNALING

(71) Applicant: QUALCOMM Incorporated, San Diego, CA (US)

(72) Inventors: Huilin XU, Temecula, CA (US); Kazuki TAKEDA, Tokyo (JP); Peter GAAL, San Diego, CA (US)

(21) Appl. No.: 18/890,919

(22) Filed: Sep. 20, 2024

(51) Int. Cl. H04W 52/02; H04W 76/28

(52) U.S. Cl. CPC H04W 52/0229; H04W 76/28

(57) ABSTRACT

Various aspects of the present disclosure generally relate to wireless communication. In some aspects, a first network entity may receive, from a second network entity, configuration information indicating first discontinuous reception (DRX) cycle information and second DRX cycle information, wherein the first DRX cycle information is associated with activated low-power wakeup signaling, and wherein the second DRX cycle information is associated with deactivated low-power wakeup signaling. The first network entity may monitor a control channel in accordance with either the first DRX cycle information, based on low-power wakeup signal detection being activated, or the second DRX cycle information, based on low-power wakeup signal detection being deactivated. Numerous other aspects are described.

### FIELD OF THE DISCLOSURE

Aspects of the present disclosure generally relate to wireless communication and specifically relate to techniques, apparatuses, and methods associated with discontinuous reception cycles for low-power wakeup signaling.

### INTRODUCTION

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, a first network entity includes a processing system, configured to: receive, from a second network entity, configuration information indicating first discontinuous reception (DRX) cycle information and second DRX cycle information, wherein the first DRX cycle information is associated with activated low-power wakeup signaling, and wherein the second DRX cycle information is associated with deactivated low-power wakeup signaling; and monitor a control channel in accordance with either the first DRX cycle information, based on low-power wakeup signal detection being activated, or the second DRX cycle information, based on low-power wakeup signal detection being deactivated.

In some aspects, a method of wireless communication performed by a first network entity includes receiving, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and monitoring a control channel in accordance with either the first DRX cycle information, based on low-power wakeup signal detection being activated, or the second DRX cycle information, based on low-power wakeup signal detection being deactivated.

In some aspects, a non-transitory computer-readable medium having code thereon that, when executed by one or more processors of a first network entity, cause the first network entity to: receive, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and monitor a control channel in accordance with either the first DRX cycle information, based on low-power wakeup signal detection being activated, or the second DRX cycle information, based on low-power wakeup signal detection being deactivated.

In some aspects, an apparatus for wireless communication includes means for receiving, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and means for monitoring a control channel in accordance with either the first DRX cycle information, based on low-power wakeup signal detection being activated, or the second DRX cycle information, based on low-power wakeup signal detection being deactivated.

In some aspects, a first network entity includes a processing system, configured to: transmit, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and transmit one or more communications in accordance with either the first DRX cycle information, based on low-power wakeup signal detection being activated, or the second DRX cycle information, based on low-power wakeup signal detection being deactivated.

In some aspects, a method of wireless communication performed by a first network entity includes transmitting, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and transmitting one or more communications in accordance with either the first DRX cycle information, based on low-power wakeup signal detection being activated, or the second DRX cycle information, based on low-power wakeup signal detection being deactivated.

In some aspects, a non-transitory computer-readable medium having code thereon that, when executed by one or more processors of a first network entity, cause the first network entity to: transmit, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and transmit one or more communications in accordance with either the first DRX cycle information, based on low-power wakeup signal detection being activated, or the second DRX cycle information, based on low-power wakeup signal detection being deactivated.

In some aspects, an apparatus for wireless communication includes means for transmitting, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and means for transmitting one or more communications in accordance with either the first DRX cycle information, based on low-power wakeup signal detection being activated, or the second DRX cycle information, based on low-power wakeup signal detection being deactivated.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network, in accordance with the present disclosure.

FIG. 3 is a diagram illustrating an example disaggregated network node architecture, in accordance with the present disclosure.

FIG. 4 is a diagram illustrating an example of a discontinuous reception (DRX) configuration, in accordance with the present disclosure.

FIG. 5 is a diagram illustrating an example of an low-power wakeup radio and a low-power wakeup signal, in accordance with the present disclosure.

FIG. 6 is a diagram illustrating an example of low-power wakeup signaling for DRX cycles, in accordance with the present disclosure.

FIG. 7 is a diagram of an example associated with DRX cycles for low-power wakeup signaling, in accordance with the present disclosure.

FIG. 8 is a diagram of an example associated with DRX cycles for low-power wakeup signaling, in accordance with the present disclosure.

FIG. 9 is a diagram illustrating an example process performed, for example, at a first network entity or an apparatus of a first network entity, in accordance with the present disclosure.

FIG. 10 is a diagram illustrating an example process performed, for example, at a first network entity or an apparatus of a first network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. The scope of the disclosure covers any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure covers an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Communications (e.g., transmission and/or reception of signals) between entities (e.g., between a user equipment (UE) and a network node) may consume some amount of power. For example, a UE may consume a lower amount of power while in a low power state (such as while not connected to a network or while waiting for paging from the network), and may consume a higher amount of power while in a full power state (such as while actively communicating with a network node or while monitoring for control information from the network). Certain components of the UE may consume a significant amount of power. For example, a radio of the UE, which may support bidirectional communication (such as both transmission and reception), multi-layer communication, or larger bandwidths (such as a communication bandwidth of the UE), may consume power while active, such as in the course of communicating or monitoring for control information.

To achieve power savings, a UE may include or be associated with a second, low-power wakeup radio (LP-WUR) in addition to a main radio. Relative to a non-LP-WUR (e.g., the main radio), the LP-WUR may have reduced power consumption. For example, the LP-WUR may be configured with a reduced bandwidth, reduced processing capabilities, or other reduced capabilities, relative to a main radio, which facilitate operation with reduced power consumption. The LP-WUR may facilitate indication, from the network, for the UE to exit a low power state, such as by waking up the main radio. For example, while the main radio is in a low power state, the LP-WUR may receive a signal referred to as a low-power wakeup signal (LP-WUS), and may trigger the main radio to exit the low power state and may trigger the UE to transfer from an idle mode to an active mode to receive downlink control channel (e.g., physical downlink control channel (PDCCH)) paging. In another example, when a UE is operating in a connected mode, the LP-WUS may trigger UE PDCCH monitoring.

As described elsewhere herein, low-power wakeup signaling can be used in association with discontinuous reception (DRX) cycles (e.g., connected mode DRX (C-DRX) cycles) to further improve power savings of the UE. For example, in some cases, the UE may monitor for an LP-WUS (e.g., in a configured LP-WUS monitoring occasion) using the LP-WUR. The LP-WUS monitoring occasion may be configured to occur before an on duration of a DRX cycle. If the UE detects an LP-WUS during an LP-WUS monitoring occasion, then the UE may turn on a main radio during a corresponding (e.g., a next in time) on duration (e.g., and monitor the PDCCH during the on duration using the main radio). If the UE does not detect an LP-WUS during an LP-WUS monitoring occasion, then the UE may keep the main radio in an inactive state or an off state during a corresponding (e.g., a next in time) on duration (e.g., and refrain from monitoring the PDCCH during the on duration using the main radio). This enables the UE to keep the main radio in an inactive state or an off state during the given on duration, thereby conserving power that would have otherwise been associated with the UE powering on the main radio and monitoring the PDCCH during the given on duration when the network node is not transmitting a communication to the UE during the given on duration.

Additionally, or alternatively, low-power wakeup signaling can be used to trigger or cause the UE to monitor the PDCCH outside of an on duration of the DRX cycle. For example, the UE may receive configuration information indicative one or more PDCCH monitoring occasions (PMOs) that occur outside of on durations of the DRX cycle. The one or more PMOs provide additional opportunities for the UE to wake up (e.g., to power on the main radio) to monitor for and/or receive PDCCH communications. For example, if the UE detects an LP-WUS during an LP-WUS monitoring occasion corresponding to a given PMO, then the UE may turn on a main radio during the corresponding (e.g., a next in time) PMO (e.g., and monitor the PDCCH during the corresponding PMO using the main radio). If the UE does not detect an LP-WUS during an LP-WUS monitoring occasion corresponding to a given PMO, then the UE may keep the main radio in an inactive state or an off state during the corresponding (e.g., a next in time) PMO (e.g., and refrain from monitoring the PDCCH during the corresponding PMO using the main radio). In this way, LP-WUS monitoring outside an active time (e.g., an on duration) of the DRX cycle according to an LP-WUS monitoring configuration can trigger PDCCH monitoring (e.g., during a PMO). While the PMO(s) provide additional opportunities for the UE to receive PDCCH communications, the UE may have to receive additional configuration information for the PMO(s), thereby increasing signaling overhead. Further, this introduces additional configurations to be maintained and/or coordinated by the UE, increasing complexity associated with the low-power wakeup signaling monitoring.

In some examples, a duration of the DRX cycle could be decreased to provide additional opportunities for the UE to receive PDCCH communications in a similar manner as described in connection with the PMO(s). However, in some cases, the UE may dynamically activate or deactivate LP-WUS monitoring (e.g., based on signal parameter(s) of received LP-WUS(s), such as signal strength or signal quality). For example, if the signal strength of one or more received LP-WUSs does not satisfy a threshold, then the UE may deactivate LP-WUS monitoring and may fallback to legacy behavior in which the UE monitors the PDCCH using the main radio in each configured on duration (e.g., independent of or regardless of whether an LP-WUS is received because the UE does not monitor for the LP-WUS). In examples where the duration of the DRX cycle is decreased to provide additional opportunities for the UE to receive PDCCH communications, the deactivation of the LP-WUS monitoring may result in increased power consumption for the UE because the UE may monitor the PDCCH more frequently due to the decreased duration of the DRX cycle.

Various aspects relate generally to DRX cycles for low-power wakeup signaling. Some aspects more specifically relate to configuring different parameters for a DRX configuration (e.g., a connected mode DRX configuration) for active low-power wakeup signal monitoring and deactivated wakeup signal monitoring. For example, a UE may receive a first one or more DRX parameters that are applicable when low-power wakeup signal monitoring is active at the UE and a second one or more DRX parameters that are applicable when low-power wakeup signal monitoring is inactive at the UE. In some aspects, the UE may receive first DRX cycle information and second DRX cycle information, where the first DRX cycle information is associated with activated low-power wakeup signaling, and where the second DRX cycle information is associated with deactivated low-power wakeup signaling. In some aspects, the first DRX cycle information may indicate a first DRX cycle duration and the second DRX cycle information may indicate a second DRX cycle duration. In some aspects, the first DRX cycle duration may be shorter than the second DRX cycle duration (e.g., the UE may use a shorter DRX cycle duration when low-power wakeup signal monitoring is active and a longer DRX cycle duration when low-power wakeup signal monitoring is inactive).

The UE may monitor a control channel (e.g., the PDCCH) in accordance with either the first DRX cycle information, based on low-power wakeup signal detection being activated, or the second DRX cycle information, based on low-power wakeup signal detection being deactivated. For example, if low-power wakeup signal detection or monitoring is active (e.g., if an LP-WUR of the UE is being used to monitor for LP-WUSs), then the UE may monitor the control channel in accordance with a first DRX cycle duration indicated by the first DRX cycle information. Alternatively, if low-power wakeup signal detection or monitoring is deactivated (e.g., if an LP-WUR of the UE is not being used to monitor for LP-WUSs), then the UE may monitor the control channel in accordance with a second DRX cycle duration indicated by the first DRX cycle information.

Particular aspects of the subject matter described in this disclosure can be implemented to realize one or more of the following potential advantages. In some examples, by the UE being configured with separate DRX parameter(s) for active LP-WUS monitoring and inactive LP-WUS monitoring, the described techniques can be used to increase PDCCH reception opportunities for the UE when LP-WUS monitoring is active while also reducing the likelihood of excessive power consumption for the UE when LP-WUS monitoring is inactive. For example, by the UE being configured with a shorter DRX cycle duration that is applicable when LP-WUS monitoring is active, on durations of the DRX cycle may occur more frequently over time, increasing the quantity of PDCCH reception opportunities for the UE (e.g., without increased risk of excessive power consumption because the UE will only turn on a main radio and/or monitor the PDCCH during an on duration if an LP-WUS is detected). Additionally, by the UE being configured with a longer DRX cycle duration that is applicable when LP-WUS monitoring is inactive, on durations of the DRX cycle may occur less frequently over time, thereby reducing the risk of excessive power consumption by the UE. This provides a uniform framework within a DRX configuration to enable the UE and/or a network node to balance increasing PDCCH reception opportunities for the UE with power consumption by the UE. Additionally, by the UE being configured with separate DRX parameter(s) for active LP-WUS monitoring and inactive LP-WUS monitoring, a single configuration (e.g., a single DRX configuration) can configure UE behavior applicable when LP-WUS monitoring is active and when LP-WUS monitoring is inactive, thereby reducing signaling overhead that would have otherwise been associated with the UE receiving separate configurations (e.g., a DRX configuration and a PDCCH monitoring occasion configuration) to configure the UE behavior.

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

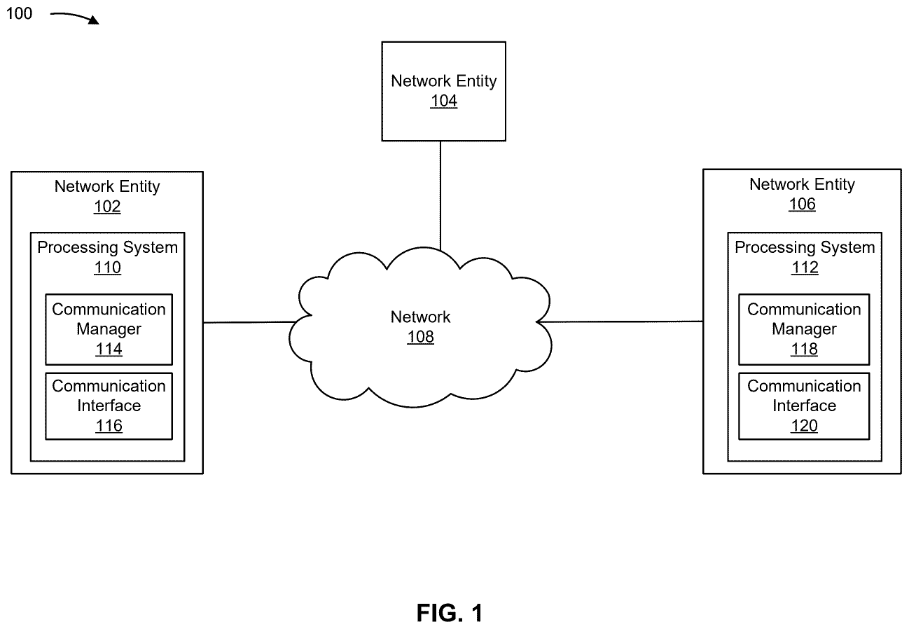

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

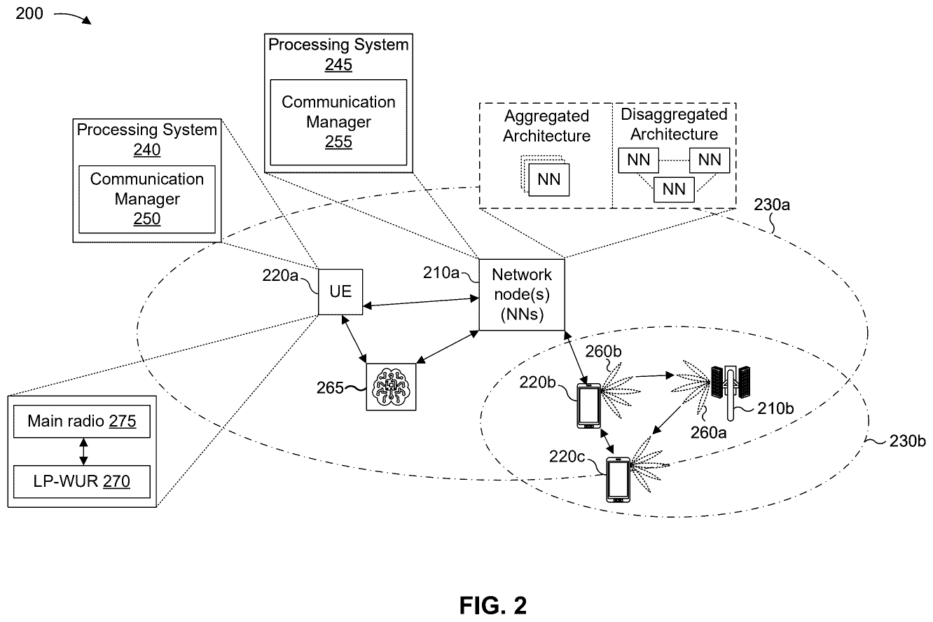

The network 108 may include, for example, a cellular network (e.g., a Long-Term Evolution (LTE) network, a CDMA network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) receive, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and/or monitor a control channel in accordance with either the first DRX cycle information, based on low-power wakeup signal detection being activated, or the second DRX cycle information, based on low-power wakeup signal detection being deactivated. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 114 and/or the communication interface 116 to) transmit, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and/or transmit one or more communications in accordance with either the first DRX cycle information, based on low-power wakeup signal detection being activated, or the second DRX cycle information, based on low-power wakeup signal detection being deactivated. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200, in accordance with the present disclosure. The wireless communication network 200 may be or may include elements of a 5G (or NR) network or a 6G network, among other examples. The wireless communication network 200 may include multiple network nodes 210. For example, in FIG. 2, the wireless communication network 200 includes a network node (NN) 210a and a network node 210b. The network nodes 210 may support communications with multiple UEs 220. For example, in FIG. 2, the network nodes 210 support communication with a UE 220a, a UE 220b, and a UE 220c. In some examples, a UE 220 may also communicate with other UEs 220 and a network node 210 may communicate with a core network and with other network nodes 210.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands. In some aspects, multiple wireless communication networks 200 may be deployed in a given geographic area. Each wireless communication network 200 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 200 may implement dynamic spectrum sharing (DSS), in which multiple RATs are implemented with dynamic bandwidth allocation (for example, based on user demand) in a single frequency band. In some examples, the wireless communication network 200 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 210 and/or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system, such as a processing system 240 of the UE 220 or a processing system 245 of the network node 210. The processing system 240 and the processing system 245 may be similar to other processing systems described herein, such as the processing system 110 and the processing system 112. A processing system (for example, the processing system 240 and/or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 and/or the processing system 245 include or implement one or more of the modems. The processing system 240 and the processing system 245 may also include or be coupled with multiple radios (collectively “the radio”), multiple RF chains, or multiple transceivers, each of which may in turn be coupled with one or more of multiple antennas. In some examples, one or more processors of the processing system 240 and/or the processing system 245 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 240 of the UE 220 or by the processing system 245 of the network node 210).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 210 and the UE 220.

A network node 210 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may consist of a single standalone base station or a single TRP that operates with a full radio protocol stack to enable or facilitate communication between a UE 220 and a core network of the wireless communication network 200.

Alternatively, and as also shown, a network node 210 may be a disaggregated network node (sometimes referred to as a disaggregated base station), having a disaggregated architecture, meaning that the network node 210 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 210 (for example, a base station, an RU, or a TRP) may provide communication coverage for a particular geographic area. The term “cell” can refer to a coverage area of a network node 210 or to a network node 210 itself, depending on the context in which the term is used. A network node 210 may support one or more cells (for example, each cell may support communication within an angular (for example, 60 degree) range around the network node). In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with associated service subscriptions. A pico cell may cover a relatively small geographic area and may also allow unrestricted access by UEs 220 with associated service subscriptions. A femto cell may cover a relatively small geographic area (for example, a home) and may allow restricted access by UEs 220 having association with the femto cell (for example, UEs 220 in a closed subscriber group (CSG)). In some examples, a cell may not necessarily be stationary. For example, the geographic area of the cell may move according to the location of an associated mobile network node 210 (for example, a train, a satellite, an unmanned aerial vehicle, or an NTN network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. Various different types of network nodes 210 may generally transmit at different power levels, serve different coverage areas (for example, a cell 230a and a cell 230b), and/or have different impacts on interference in the wireless communication network 200 than other types of network nodes 210.

The UEs 220 may be physically dispersed throughout the coverage area of the wireless communication network 200, and each UE 220 may be stationary or mobile. A UE 220 may be, may include, or may also be referred to as an access terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 200, among other examples. A third category of UEs 220 may have mid-tier complexity and/or capability (for example, a capability between that of the UEs 220 of the first category and that of the UEs 220 of the second capability). A UE 220 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) and/or reconfigured (for example, in real-time or near-real-time) according to changing network conditions in the wireless communication network 200 and/or specific requirements of one or more UEs 220. An active BWP defines the operating bandwidth of the UE 220 within the operating bandwidth of the serving cell. The use of BWPs enables more efficient use of the available frequency domain resources in the wireless communication network 200 because fewer frequency domain resources may be allocated to a BWP for a UE 220 (which may reduce the quantity of frequency domain resources that a UE 220 is required to monitor and reduce UE power consumption by enabling the UE to monitor fewer frequency domain resources), leaving more frequency domain resources to be spread across multiple UEs 220. Thus, BWPs may also assist in the implementation of lower-capability (for example, RedCap) UEs 220 by facilitating the configuration of smaller bandwidths for communication by such UEs 220 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220. The network node 210 may transmit, to the UE 220, an indication of the selected MCS for the downlink signal, such as via DCI that schedules the downlink signal. As another example, the network node 210 may transmit, and the UE 220 may receive, an indication of an MCS to be applied for the one or more uplink signals, such as via DCI scheduling transmission of the one or more uplink signals.

The network node 210 or the UE 220 (such as by using the processing system 245 or the processing system 240, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 210 or the UE 220 (for example, using the processing system 245 or the processing system 240, respectively, and/or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 and/or one or more modems) may further perform spatial processing (for example, precoding) on the encoded information to generate one or more processed or precoded signals for downlink or uplink transmission, respectively. In some examples, the network node 210 or the UE 220 may perform codebook-based precoding or non-codebook-based precoding. Codebook-based precoding may involve selecting a precoder (for example, a precoding matrix) using a codebook. For example, the network node 210 may provide precoding information indicating which precoder, defined by the codebook, is to be used by the UE 220. Non-codebook-based precoding may involve selecting or deriving a precoder based on, or otherwise associated with, one or more downlink or uplink signal measurements. The network node 210 or the UE 220 may transmit the processed downlink or uplink signals, respectively, via one or more antennas.

The network node 210 or the UE 220 may receive uplink signals or downlink signals, respectively, via one or more antennas. The network node 210 or the UE 220 (for example, using the processing system 245 or the processing system 240, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 210 or the UE 220 via the downlink or uplink signals. The network node 210 or the UE 220 (for example, using the processing system 245 or the processing system 240, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

Communications (e.g., transmission and/or reception of signals) between entities (e.g., between a UE 220 and a network node 210) may consume some amount of power. For example, a UE 220 may consume a lower amount of power while in a low power state (such as while not connected to a network or while waiting for paging from the network), and may consume a higher amount of power while in a full power state (such as while actively communicating with a network node or while monitoring for control information from the network). Certain components of the UE 220 may consume a significant amount of power. For example, a radio of the UE 220, which may support bidirectional communication (such as both transmission and reception), multi-layer communication, or larger bandwidths (such as a communication bandwidth of the UE 220), may consume power while active, such as in the course of communicating or monitoring for control information.

Some techniques provide power savings at the UE 220 by limiting the amount or ratio of time in which a radio is active, relative to the amount of time in which the radio is inactive or powered down. For example, a C-DRX cycle may provide off durations (sometimes referred to as inactive times or sleep durations) in which the radio is inactive, and on durations (sometimes referred to as active times or wake durations) in which the radio is active. The UE 220 may monitor for a PDCCH during an on duration, and may extend the on duration if a PDCCH is received, which facilitates further communication in accordance with the PDCCH. Thus, power consumption of the main radio may be reduced by reducing the amount of time in which the main radio is active and/or monitoring for a PDCCH.

While the C-DRX cycle reduces power consumption at the UE 220 and the network, further power savings may be desirable, particularly in 5G, 6G, and similar RATs where beamforming and high-frequency communication cause increased power consumption relative to other RATs. To achieve further power savings, a UE 220 (such as the UE 220a as shown in FIG. 2) may include or be associated with a second LP-WUR 270. Relative to a non-LP-WUR (e.g., a main radio (MR) 275 of the UE 220), the LP-WUR 270 may have reduced power consumption. For example, the LP-WUR 270 may be configured with a reduced bandwidth, reduced processing capabilities, or other reduced capabilities, relative to a main radio, which facilitate operation with reduced power consumption. In one particular example, the LP-WUR 270 may be configured to use an envelope detector type of receiver architecture, with on-off keying (OOK) modulation, to enable the UE 220a to perform signaling monitoring with low power consumption.

The LP-WUR 270 may facilitate indication, from the network, for the UE 220a to exit a low power state, such as by waking up the main radio 275. For example, while the main radio 275 is in a low power state, the LP-WUR 270 may receive a signal referred to as an LP-WUS, and may trigger the main radio to exit the low power state and may trigger a UE 220a to transfer from an idle mode to an active mode to receive PDCCH paging. In another example, when a UE 220a is operating in a connected mode, the LP-WUS may trigger UE PDCCH monitoring. In some configurations, the LP-WUS and/or LP-WUR 270 can be implemented in conjunction with a C-DRX cycle, such that the UE 220a may keep the main radio 275 in an inactive state or off state during an on duration of the C-DRX cycle if the LP-WUR 270 has not received or detected an LP-WUS in association with (e.g., before) the on duration, thereby further reducing power consumption relative to the UE 220a waking up (e.g., powering on the main radio 275) during an on duration in which the UE 220a will not receive a PDCCH.

In some examples, a UE 220 and a network node 210 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 210 and/or UE 220 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 210b may generate one or more beams 260a, and the UE 220b may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 210 and/or at the UE 220, such as in a network implementing mmWave technology. Massive MIMO may improve communication reliability by enabling a network node 210 and/or a UE 220 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 210 and the UE 220 may perform one or more beam management operations, such as an initial beam acquisition operation, one or more beam refinement operations, and/or a beam recovery operation. For example, an initial beam acquisition operation may involve the network node 210 transmitting signals (for example, SSBs, CSI-RSs, or other signals) via respective beams (for example, of the beams 260a of the network node 210) and the UE 220 receiving and measuring the signal(s) via respective beams of multiple beams (for example, from the beams 260b of the UE 220) to identify a best beam (or beam pair) for communication between the UE 220 and the network node 210. For example, the UE 220 may transmit an indication (for example, in a message associated with a random access channel (RACH) operation) of a (best) identified beam of the network node 210 (for example, by indicating an SSBRI or other identifier associated with the beam). A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 210 and the UE 220 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 265 (for example, a network node 210 and/or UEs 220). For example, the one or more devices 265 may include a UE 220 (for example, the processing system 240), a network node 210 (for example, the processing system 245), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 220 and a second portion of the AI/ML model may be deployed at a network node 210). In other examples, a first AI/ML model may be deployed at a UE 220 and a second AI/ML model may be deployed at a network node 210. The AI/ML model(s) may be configured to enhance various aspects of the wireless communication network 200. For example, the AI/ML model(s) may be trained to identify patterns or relationships in data corresponding to the wireless communication network 200, a device, and/or an air interface, among other examples. The AI/ML model(s) may support operational decisions relating to one or more aspects associated with wireless communications devices, networks, or services.

In some aspects, the UE 220 may include a communication manager 250. As described in more detail elsewhere herein, the communication manager 250 may receive, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and monitor a control channel in accordance with either the first DRX cycle information, based on low-power wakeup signal detection being activated, or the second DRX cycle information, based on low-power wakeup signal detection being deactivated. Additionally, or alternatively, the communication manager 250 may perform one or more other operations described herein.

In some aspects, the network node 210 may include a communication manager 255. As described in more detail elsewhere herein, the communication manager 255 may transmit, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and transmit one or more communications in accordance with either the first DRX cycle information, based on low-power wakeup signal detection being activated, or the second DRX cycle information, based on low-power wakeup signal detection being deactivated. Additionally, or alternatively, the communication manager 250 may perform one or more other operations described herein.

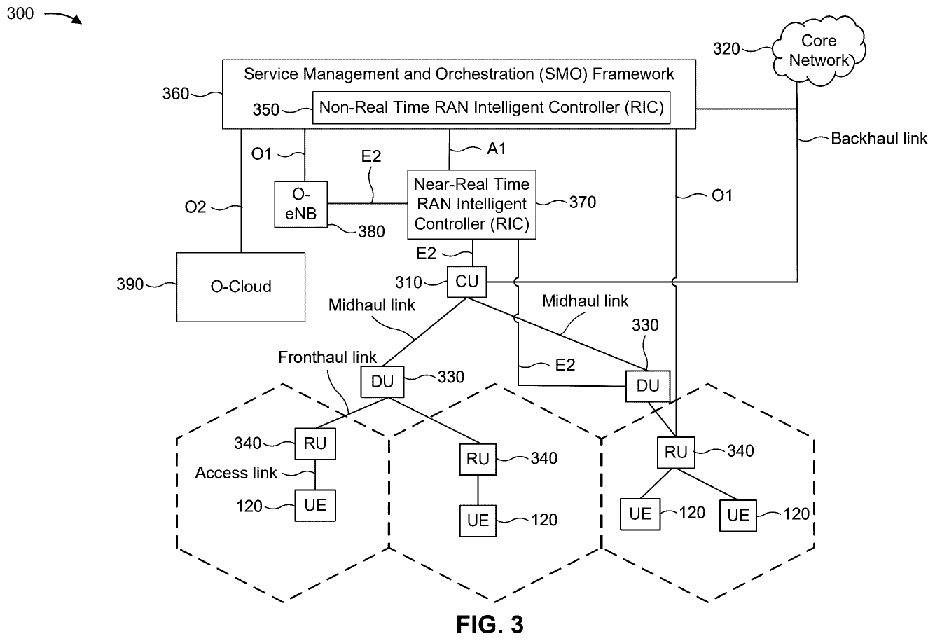

FIG. 3 is a diagram illustrating an example disaggregated network node architecture 300, in accordance with the present disclosure. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 and/or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

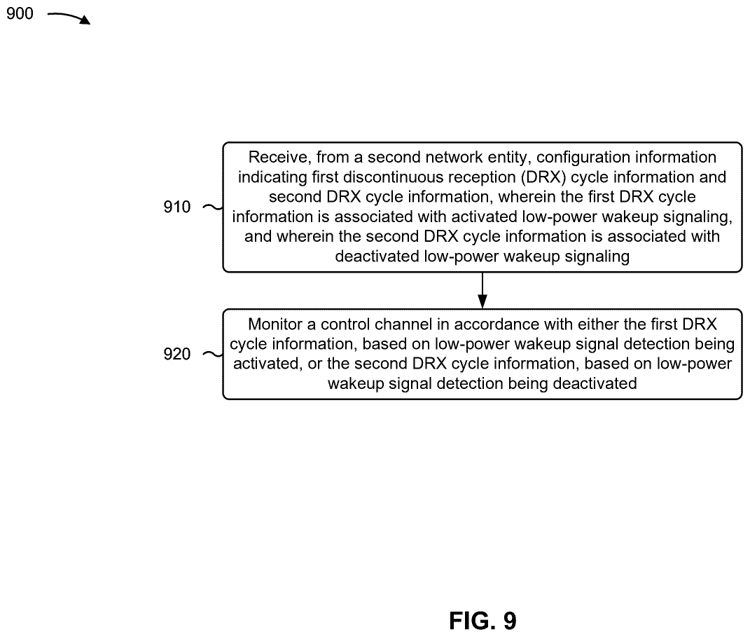

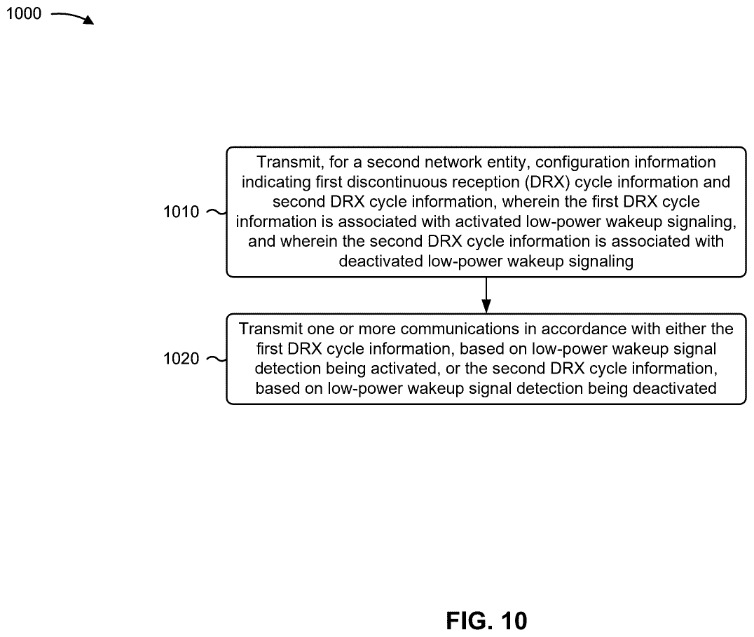

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with DRX cycles for low-power wakeup signaling, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 900 of FIG. 9, process 1000 of FIG. 10, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

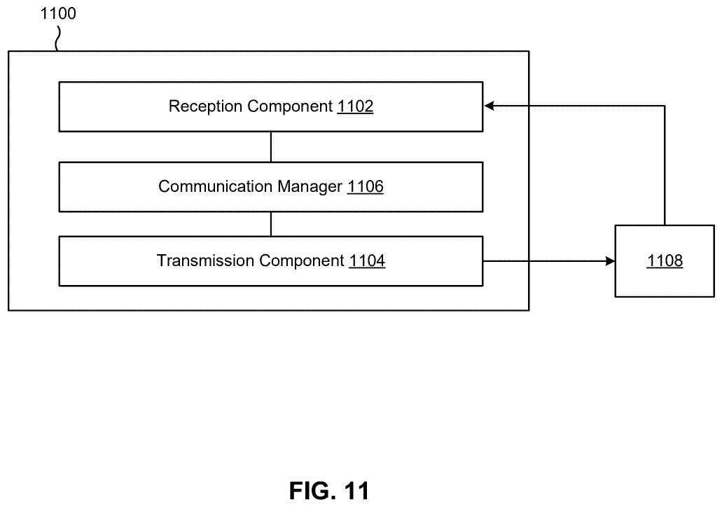

In some aspects, a first network entity includes means for receiving, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and/or means for monitoring a control channel in accordance with either the first DRX cycle information, based on low-power wakeup signal detection being activated, or the second DRX cycle information, based on low-power wakeup signal detection being deactivated. In some aspects, the means for the first network entity to perform operations described herein may include, for example, one or more of communication manager 245, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1102 depicted and described in connection with FIG. 11) and/or a transmission component (for example, transmission component 1104 depicted and described in connection with FIG. 11), among other examples.

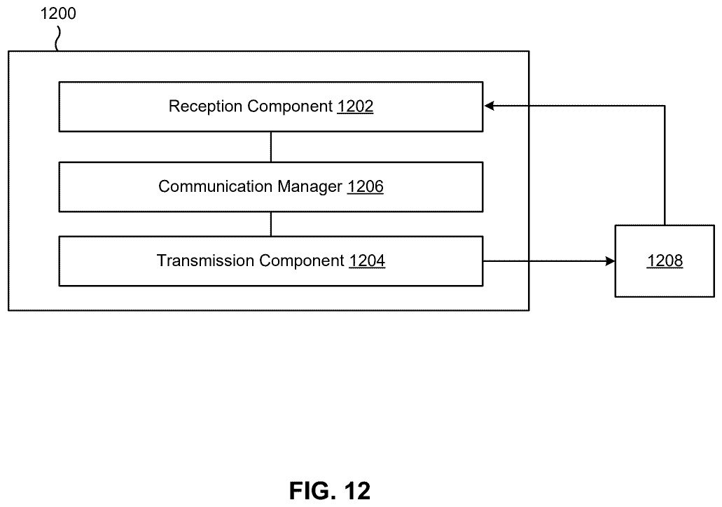

In some aspects, a first network entity includes means for transmitting, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling; and/or means for transmitting one or more communications in accordance with either the first DRX cycle information, based on low-power wakeup signal detection being activated, or the second DRX cycle information, based on low-power wakeup signal detection being deactivated. In some aspects, the means for the first network entity to perform operations described herein may include, for example, one or more of communication manager 255, processing system 250, processing system 110, communication manager 114, communication interface 116, processing system 112, communication manager 118, communication interface 120, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

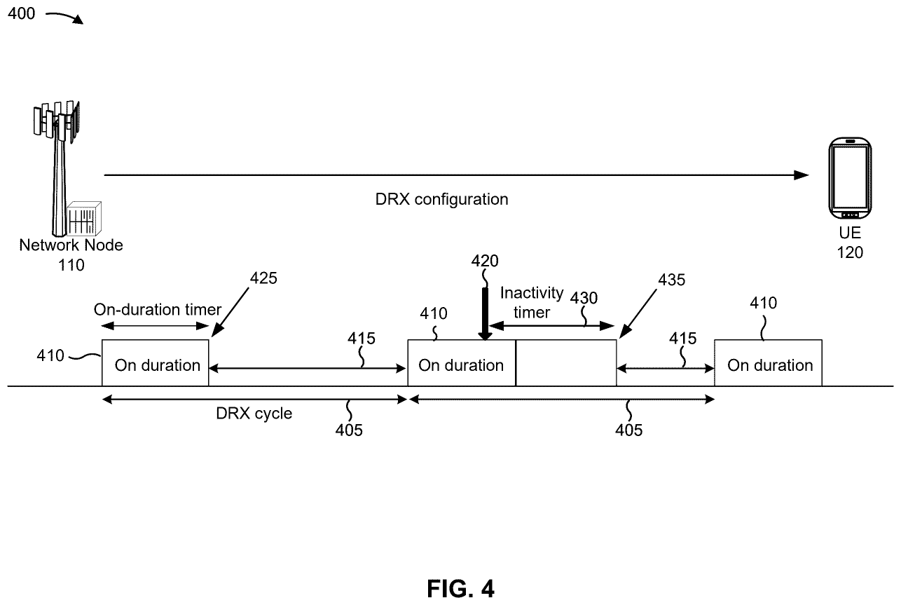

FIG. 4 is a diagram illustrating an example 400 of a DRX configuration, in accordance with the present disclosure.

As shown in FIG. 4, a network node 210 may transmit a DRX configuration to a UE 220 to configure a DRX cycle 405 for the UE 220 in an RRC connected state. A DRX cycle 405 may include a DRX on duration 410 (e.g., during which a UE 220 is awake or in an active state) and an opportunity to enter a DRX sleep state 415. As used herein, the time during which the UE 220 is configured to be in an active state during the DRX on duration 410 may be referred to as an active time, and the time during which the UE 220 is configured to be in the DRX sleep state 415 may be referred to as an inactive time. As described below, the UE 220 may monitor a PDCCH during the active time, and may refrain from monitoring the PDCCH during the inactive time. As used herein, a “DRX cycle,” a “duration” of a DRX cycle, or a “length” of a DRX cycle may refer to the amount of time between the start of two consecutive or adjacent (e.g., in time) on durations 410.

During the DRX on duration 410 (e.g., the active time), the UE 220 may monitor a downlink control channel (e.g., a PDCCH), as shown by reference number 420. For example, the UE 220 may monitor the PDCCH for DCI pertaining to the UE 220. If the UE 220 does not detect and/or successfully decode any PDCCH communications intended for the UE 220 during the DRX on duration 410, then the UE 220 may enter the sleep state 415 (e.g., for the inactive time) at the end of the DRX on duration 410, as shown by reference number 425. In this way, the UE 220 may conserve battery power and reduce power consumption. As shown, the DRX cycle 405 may repeat with a configured periodicity according to the DRX configuration.

If the UE 220 detects and/or successfully decodes a PDCCH communication intended for the UE 220, then the UE 220 may remain in an active state (e.g., awake) for the duration of a DRX inactivity timer 430 (e.g., which may extend the active time). The UE 220 may start the DRX inactivity timer 430 at a time at which the PDCCH communication is received (e.g., in a transmission time interval (TTI) in which the PDCCH communication is received, such as a slot or a subframe). The UE 220 may remain in the active state until the DRX inactivity timer 430 expires, at which time the UE 220 may enter the sleep state 415 (e.g., for the inactive time), as shown by reference number 435. During the duration of the DRX inactivity timer 430, the UE 220 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a PUSCH) scheduled by the PDCCH communication. The UE 220 may restart the DRX inactivity timer 430 after each detection of a PDCCH communication for the UE 220 for an initial transmission (e.g., but not for a retransmission). By operating in this manner, the UE 220 may conserve battery power and reduce power consumption by entering the sleep state 415.

As indicated above, FIG. 4 is provided as an example. Other examples may differ from what is described with respect to FIG. 4.

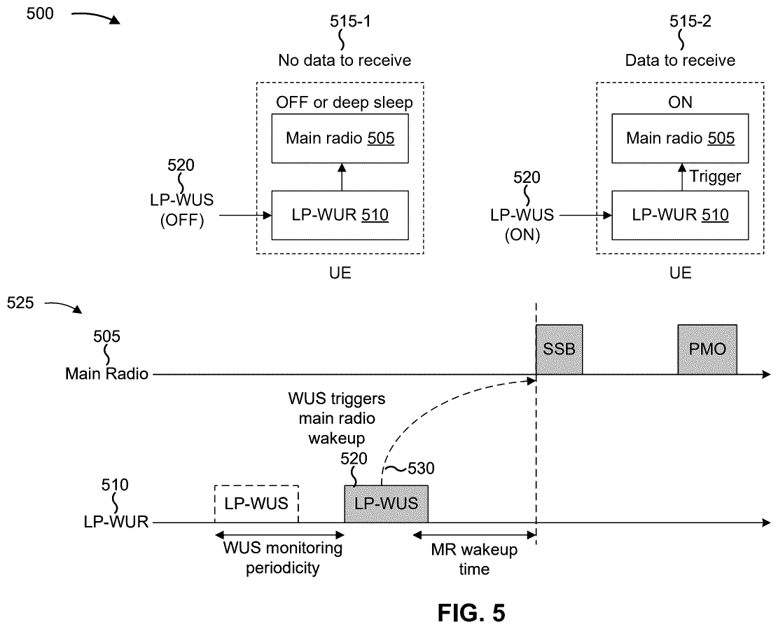

FIG. 5 is a diagram illustrating an example 500 of an LP-WUR and an LP-WUS, in accordance with the present disclosure. As shown in FIG. 5, a UE (such as UE 220) may be equipped with a communication system that includes a main radio (illustrated as “MR”) 505 (e.g., the main radio 275) and an LP-WUR 510 (e.g., the LP-WUR 270) to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 5, the UE may be equipped with the LP-WUR 510, which may be considered a companion receiver that can be used with a main radio 505 to reduce power consumption and latency.

For example, in some aspects, the UE may generally use the main radio 505 to transmit and/or receive user data, and the main radio 505 may be turned off or operated in a deep sleep state unless there is user data to transmit and/or receive. Furthermore, the LP-WUR 510 may serve as a simple wakeup receiver for the main radio 505, and the LP-WUR 510 may be active and monitoring for an LP-WUS while the main radio 505 is off or in the deep sleep state. For example, reference number 515-1 depicts a first state associated with the main radio 505 and the LP-WUR 510 where there is no user data to be provided to the main radio 505. In such cases, the main radio 505 may be off or operated in the deep sleep state unless there is user data to transmit, and the LP-WUR 510 may monitor for an LP-WUS (for example, continuously, or periodically in monitoring occasions that are separated in time). Furthermore, reference number 515-2 depicts a second state associated with the main radio 505 and the LP-WUR 510 where there is user data for the main radio 505. In such examples, the LP-WUR 510 may receive an LP-WUS 520 (such as from a network node 210) and may provide a trigger to wake or otherwise activate the main radio 505 based on detecting the LP-WUS 520. Accordingly, the main radio 505 may then transmit and/or receive user data.

In general, the LP-WUR 510 may consume very little power (for example a target power consumption less than 100 microwatts (μW) in the active state), which may be achieved using simple modulation schemes (for example, on-off keying (OOK)), a narrow bandwidth (for example, less than 5 MHz), and/or other suitable techniques. In this way, the LP-WUR 510 can be used to reduce the time that the main radio 505 spends in an on state and/or may avoid unnecessarily waking the main radio 505 from the off or deep sleep state when there is no user data to transmit or receive, which tends to be costly from a power consumption perspective. Furthermore, because the LP-WUR 510 has a very low power consumption, the LP-WUR 510 can be used to frequently or continuously perform LP-WUS monitoring, which may improve latency because the main radio 505 can be woken up when there is user data that the main radio 505 needs to receive. For example, the LP-WUR 510 may not suffer from the latency versus power efficiency tradeoff associated with duty cycling schemes, such as DRX. In some examples, an LP-WUS and/or the LP-WUR 510 can be implemented in conjunction with a DRX cycle (e.g., a C-DRX cycle, such as a DRX cycle 405), such that the UE may not turn on a main radio 505 during on duration (e.g., an on duration 410) of the DRX cycle if the LP-WUR 510 has not received or detected an LP-WUS in association with (e.g., before) the on duration, thereby further reducing power consumption relative to waking up the main radio 505 in an on duration in which the will not receive a PDCCH. Furthermore, in addition to performing LP-WUS monitoring, which may be used for triggering PDCCH monitoring, the LP-WUR 510 may monitor a low power synchronization signal (LP-SS) for time and frequency tracking and radio resource management (RRM) measurement. In this way, by monitoring the LP-SS, serving cell and/or neighbor cell monitoring can be offloaded from the main radio 505 to the LP-WUR 510 to reduce how often the main radio 505 is woken up, which can further reduce power consumption.

In some aspects, the LP-WUR 510 may include an OOK WUR (also referred to as an envelope detector (ED) WUR). An OOK WUR may only detect the amplitude (such as the magnitude) of a received signal. A UE that uses an OOK WUR may detect the phase of a received signal by activating the MR 505.

In some aspects, the LP-WUR 510 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 525, one application of the LP-WUR 510 is to monitor the LP-WUS 520 for control channel (e.g., PDCCH) monitoring for UEs in the RRC connected state, which can be used to reduce unnecessary paging reception performed by the main radio 505. For example, as shown in FIG. 5, the LP-WUR 510 may be configured to monitor for an LP-WUS 520 (while the main radio 505 is off or in a deep sleep state) according to a WUS monitoring periodicity. For example, the LP-WUR 510 may monitor for the LP-WUS 520 in periodic LP-WUS monitoring occasions that are spaced in time according to the WUS monitoring periodicity. Alternatively, although not explicitly shown in FIG. 5, the LP-WUR 510 may be configured to continuously monitor for the LP-WUS 520. In general, a network node may transmit an LP-WUS 520 to a UE only in cases where there is a control channel message that needs to be sent to the UE while the UE is in an active (such as an RRC connected state). In such cases, as shown by reference number 530, the LP-WUR 510 may receive and detect the LP-WUS 520, which may trigger the LP-WUR 510 to wake up the main radio 505. In some aspects, the LP-WUS 520 may be a sequence-based WUS, which may include a predefined set of sequences (implemented, for example, using OOK modulation and/or phase modulation). As shown, the main radio 505 may wake up after a main radio wakeup time, and may then start to monitor one or more PDCCH monitoring occasions (PMOs). Otherwise, in cases where the LP-WUR 510 does not detect the LP-WUS 520, the main radio 505 may remain in the deep sleep state to save power.

As indicated above, FIG. 5 is provided as an example. Other examples may differ from what is described with respect to FIG. 5.

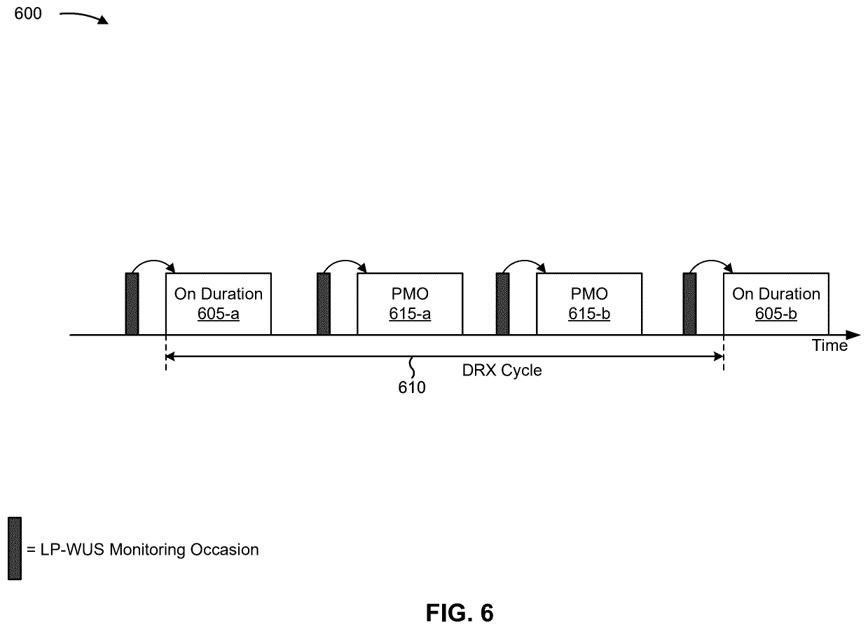

FIG. 6 is a diagram illustrating an example 600 of low-power wakeup signaling for DRX cycles, in accordance with the present disclosure.

As described elsewhere herein, low-power wakeup signaling can be used in association with DRX cycles to further improve power savings of a network entity, such as a UE. For example, in some cases, the UE may monitor for an LP-WUS (e.g., in a configured LP-WUS monitoring occasion) using an LP-WUR (e.g., the LP-WUR 270 or the LP-WUR 510). The LP-WUS monitoring occasion may be configured to occur before an on duration 605 (e.g., the on duration 605-a or the on duration 605-b as shown in FIG. 6) of a DRX cycle 610. If the UE detects an LP-WUS during an LP-WUS monitoring occasion, then the UE may turn on a main radio (e.g., the main radio 275 or the main radio 505) during a corresponding (e.g., a next in time) on duration 605 (e.g., and monitor the PDCCH during the on duration 605 using the main radio). If the UE does not detect an LP-WUS during an LP-WUS monitoring occasion, then the UE may keep the main radio in an inactive state or an off state during a corresponding (e.g., a next in time) on duration 605 (e.g., and refrain from monitoring the PDCCH during the on duration 605 using the main radio). For example, the reception or detection of an LP-WUS may trigger the UE to start a DRX on duration timer (e.g., an drx-onDurationTimer). Therefore, if a network node does not have a communication to transmit to the UE during a given on duration 605, then the network node may not transmit an LP-WUS during an LP-WUS monitoring occasion corresponding to the given on duration 605. This enables the UE to keep the main radio in an inactive state or an off state during the given on duration 605, thereby conserving power that would have otherwise been associated with the UE powering on the main radio and monitoring the PDCCH during the given on duration 605 when the network node is not transmitting a communication to the UE during the given on duration 605.

Additionally, or alternatively, low-power wakeup signaling can be used to trigger or cause the UE to monitor the PDCCH outside of an on duration 605 of the DRX cycle 610. For example, the UE may receive configuration information indicative one or more PMOs 615 (shown as a PMO 615-a and a PMO 615-b in FIG. 6) that occur outside of on durations 605 of the DRX cycle 610. The one or more PMOs 615 provide additional opportunities for the UE to wake up (e.g., to power on the main radio) to monitor for and/or receive PDCCH communications. For example, if the UE detects an LP-WUS during an LP-WUS monitoring occasion corresponding to a given PMO 615, then the UE may turn on a main radio (e.g., the main radio 275 or the main radio 505) during the corresponding (e.g., a next in time) PMO 615 (e.g., and monitor the PDCCH during the corresponding PMO 615 using the main radio). If the UE does not detect an LP-WUS during an LP-WUS monitoring occasion corresponding to a given PMO 615, then the UE may keep the main radio in an inactive state or an off state during the corresponding (e.g., a next in time) PMO 615 (e.g., and refrain from monitoring the PDCCH during the corresponding PMO 615 using the main radio). In this way, LP-WUS monitoring outside an active time (e.g., an on duration 605) of the DRX cycle 610 according to an LP-WUS monitoring configuration can trigger PDCCH monitoring (e.g., during a PMO 615). While the PMO(s) 615 provide additional opportunities for the UE to receive PDCCH communications, the UE may have to receive additional configuration information for the PMO(s) 615, thereby increasing signaling overhead. Further, this introduces additional configurations to be maintained and/or coordinated by the UE, increasing complexity associated with the low-power wakeup signaling monitoring.

In some examples, a duration of the DRX cycle 610 could be decreased to provide additional opportunities for the UE to receive PDCCH communications in a similar manner as described in connection with the PMO(s) 615. However, in some cases, the UE may dynamically activate or deactivate LP-WUS monitoring (e.g., based on signal parameter(s) of received LP-WUS(s), such as signal strength or signal quality). For example, if the signal strength of one or more received LP-WUSs does not satisfy a threshold, then the UE may deactivate LP-WUS monitoring and may fallback to legacy behavior in which the UE monitors the PDCCH using the main radio in each configured on duration (e.g., independent of or regardless of whether an LP-WUS is received because the UE does not monitor for the LP-WUS). In examples where the duration of the DRX cycle 610 is decreased to provide additional opportunities for the UE to receive PDCCH communications, the deactivation of the LP-WUS monitoring may result in increased power consumption for the UE because the UE may monitor the PDCCH more frequently due to the decreased duration of the DRX cycle 610.

As indicated above, FIG. 6 is provided as an example. Other examples may differ from what is described with respect to FIG. 6.

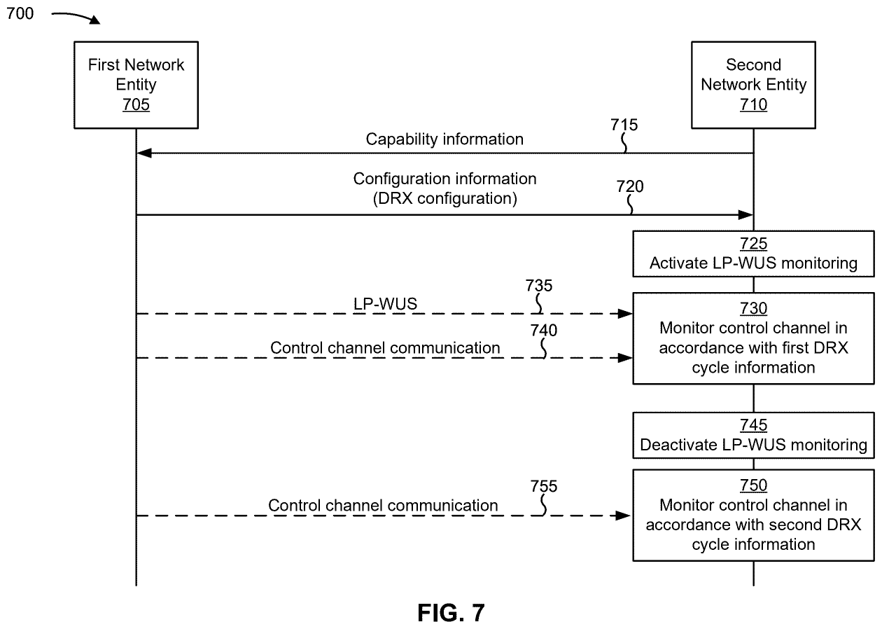

FIG. 7 is a diagram of an example 700 associated with DRX cycles for low-power wakeup signaling, in accordance with the present disclosure. As shown in FIG. 7, a first network entity 705 (e.g., the network entity 102, the network entity 104, the network entity 106, the network node 210, a base station, a CU, a DU, and/or an RU) may communicate with a second network entity 710 (e.g., the network entity 102, the network entity 104, the network entity 106, and/or the UE 220). In some aspects, the first network entity 705 and the second network entity 710 may be part of a wireless network (e.g., the wireless communication network 200 or the environment 100).

In some aspects, the second network entity 710 may include a main radio (e.g., the main radio 275 and/or the main radio 505) and a low-power radio, such as an LP-WUR (e.g., the LP-WUR 270 and/or the LP-WUR 510). For example, the second network entity 710 may be configured to monitor for signals (e.g., LP-WUSs) via the LP-WUR. The second network entity 710 may be configured to power on or power off the main radio of the second network entity 710 based on, in response to, or otherwise associated with receiving or detecting one or more signals via the LP-WUR, in a similar manner as described in more detail elsewhere herein, such as in connection with FIGS. 4-6. The second network entity 710 may be configured to dynamically switch between monitoring for LP-WUS(s) via the LP-WUR and not monitoring for LP-WUS(s) via the LP-WUR, such as based on one or more conditions (e.g., a signal strength, signal parameter, or other parameter of received LP-WUS(s) and/or instructions received from the first network entity 705, among other examples). For example, at some times, the second network entity 710 may monitor for and/or detect LP-WUS(s) via the LP-WUR. At other times, the second network entity 710 may refrain from using the LP-WUR to monitor for and/or detect LP-WUS(s) (e.g., and may only use the main radio for communications), such as when a detected signal strength or quality of received LP-WUSs is low.

As used herein, the first network entity 705 “outputting” or “transmitting” a communication to the second network entity 710 may refer to a direct transmission (for example, from the first network entity 705 to the second network entity 710) or an indirect transmission via one or more other network nodes or devices, such as one or more TRPs or access nodes. For example, if the first network entity 705 is a DU or an access node controller, an indirect transmission to the second network entity 710 may include the first network entity 705 outputting or transmitting a communication to an RU (e.g., an access node or a TRP) and the RU transmitting the communication to the second network entity 710, or may include causing the RU to transmit the communication (e.g., triggering transmission of a physical layer reference signal). Similarly, the second network entity 710 “transmitting” a communication to the first network entity 705 may refer to a direct transmission (for example, from the second network entity 710 to the first network entity 705) or an indirect transmission via one or more other network nodes or devices, such as one or more TRPs or access node. For example, if the first network entity 705 is a DU or an access node controller, an indirect transmission to the first network entity 705 may include the second network entity 710 transmitting a communication to an RU (e.g., a TRP or an access node) and the RU transmitting the communication to the first network entity 705. Similarly, the first network entity 705 “obtaining” a communication may refer to receiving a transmission carrying the communication directly (for example, from the second network entity 710 to the first network entity 705) or receiving the communication (or information derived from reception of the communication) via one or more other network nodes or devices, such as one or more TRPs or access nodes.

In some aspects, as shown by reference number 715, the second network entity 710 may optionally transmit, and the first network entity 705 may receive, capability information. The capability information may be included in a capability report. The second network entity 710 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the second network entity 710. The one or more parameters may be indicated via respective information elements (IEs) included in a capability report.

The capability information may indicate whether the second network entity 710 supports a feature and/or one or more parameters related to the feature. For example, the capability information may indicate a capability and/or parameter for supporting low-power wakeup signaling. In some examples, the capability information may indicate a capability and/or parameter for supporting multiple DRX parameters, such as first DRX parameter(s) for active low-power wakeup signaling and second DRX parameter(s) for inactive low-power wakeup signaling. One or more operations described herein may be based on capability information. For example, the second network entity 710 may perform a communication in accordance with the capability information, or may receive configuration information that is in accordance with the capability information.

In some aspects, the capability information may indicate support for switching between different DRX parameter(s) when the second network entity 710 switches between monitoring for LP-WUSs and not monitoring for LP-WUSs. For example, the capability information may indicate support for using different DRX cycle durations, such as a first DRX cycle duration when the UE is monitoring for LP-WUS(s) via the LP-WUR and a second DRX cycle duration when the UE is not monitoring for LP-WUS(s) via the LP-WUR.

The first network entity 705 may determine configuration information (e.g., DRX configuration information) based on, using, or otherwise associated with the capability information. For example, if the capability information indicates that the second network entity 710 supports different DRX parameters for active LP-WUS monitoring and inactive LP-WUS monitoring, then the first network entity 705 may determine that the configuration information is to include first DRX information (e.g., indicating a first one or more DRX parameters) that is applicable when LP-WUS monitoring is activated and second DRX information (e.g., indicating a second one or more DRX parameters) that is applicable when LP-WUS monitoring is deactivated. In other examples, the first network entity 705 may determine the configuration information without, or independent of, the capability information. For example, the first network entity 705 may determine that the second network entity 710 supports a DRX configuration that described herein based on a type, category, or other classification of the second network entity 710.

As shown by reference number 720, the first network entity 705 may transmit, and the second network entity 710 may receive, configuration information. In some aspects, the second network entity 710 may receive the configuration information via one or more of system information signaling (e.g., a master information block (MIB) and/or a system information block (SIB), among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some examples, the configuration information may not be expressly signaled to the second network entity 710. For example, in some aspects, the configuration information may at least partially be defined by a wireless communication standard, such as the 3GPP. In such examples, the first network entity 705 may not explicitly indicate such configuration information to the second network entity 710. For example, the second network entity 710 may optionally obtain at least a portion of the configuration information from a configuration stored by the second network entity 710 (e.g., an original equipment manufacturer (OEM) configuration). In some aspects, the configuration information may include a parameter or index that is indicative of information defined, or otherwise fixed, by wireless communication standard, such as the 3GPP (e.g., rather than explicitly indicating the information).

The configuration information may include, or indicate, DRX configuration information. For example, the configuration information may include an information element or field(s) for indicating DRX parameters. For example, the DRX configuration may be a connected mode DRX (C-DRX) configuration. The DRX configuration may be indicated via a drx-Config IE in an RRC configuration. As used herein, “DRX parameter” may refer to a parameter that is configured via the DRX configuration. A DRX parameter may include a DRX cycle duration (e.g., drx-ShortCycle or drx-LongCycleStartOffset), an on duration timer (e.g., drx-onDurationTimer), an inactivity timer (e.g., drx-InactivityTimer), a slot offset (e.g., drx-SlotOffset), a downlink retransmission timer (e.g., drx-RetransmissionTimerDL), an uplink retransmission timer (e.g., drx-RetransmissionTimerUL), a downlink HARQ timer (e.g., drx-HARQ-RTT-TimerDL), and/or an uplink HARQ timer (e.g., drx-HARQ-RTT-TimerUL), among other examples.

The configuration information may indicate first DRX cycle information and second DRX cycle information. The first DRX cycle information may indicate a first one or more DRX parameters. The second DRX cycle information may indicate a second one or more DRX parameters. The first DRX cycle information may be associated with activated low-power wakeup signaling. For example, the first DRX cycle information may be applicable when the second network entity 710 is monitoring for signals (e.g., LP-WUS(s)) via the LP-WUR. The second DRX cycle information may be associated with deactivated low-power wakeup signaling. For example, the second DRX cycle information may be applicable when the second network entity 710 is not monitoring for signals (e.g., LP-WUS(s)) via the LP-WUR or when the LP-WUR is deactivated or is not being used by the second network entity 710.

In some aspects, the first DRX cycle information indicates a first DRX cycle length (e.g., duration) and the second DRX cycle information may indicate a second DRX cycle length (e.g., duration). For example, the first DRX cycle information may indicate a first amount of time (e.g., the first DRX cycle length) between consecutive or adjacent on durations configured for a first DRX cycle that is to be applied for LP-WUS monitoring is activated at the second network entity 710. The second DRX cycle information may indicate a second amount of time (e.g., the second DRX cycle length) between consecutive or adjacent on durations configured for a second DRX cycle that is to be applied for LP-WUS monitoring is deactivated at the second network entity 710. In some aspects, the first DRX cycle length is shorter than the second DRX cycle length. For example, the configuration information may indicate that if LP-WUS monitoring is activated at the second network entity 710, then the second network entity 710 is to monitor a control channel (e.g., the PDCCH) in accordance with a DRX cycle having a shorter length or duration (e.g., with on durations being configured to occur more frequently in time). The configuration information may indicate that if LP-WUS monitoring is deactivated at the second network entity 710, then the second network entity 710 is to monitor the control channel (e.g., the PDCCH) in accordance with a DRX cycle having a longer length or duration (e.g., with on durations being configured to occur less frequently in time).

In some aspects, the configuration information may explicitly indicate both the first DRX cycle information and the second DRX cycle information. For example, the DRX configuration may include a first one or more fields or IEs that indicate the first DRX cycle information and a second one or more fields or IEs that indicate the second DRX cycle information.

In other examples, the second DRX cycle information may not be explicitly indicated in the configuration information. For example, the configuration information may explicitly indicate the first DRX cycle information and the second DRX cycle information may be based on the first DRX cycle information. The on durations associated with a DRX cycle for LP-WUS deactivation can implicitly or indirectly indicated from the first DRX cycle information. For example, the first DRX cycle information may indicate a set of on durations. The configuration information may indicate that a DRX cycle configured via the second DRX cycle information is a DRX cycle that includes a subset of on durations from the set of on durations. For example, the on durations for a DRX cycle (e.g., a C-DRX cycle) to be used when low-power wakeup signaling is deactivated may be a subset (e.g., a down sampling of on durations with an even or off index value) of the set of on durations configured for the DRX cycle to be used when low-power wakeup signaling is activated. The configuration information may include information indicative of the subset of on durations. For example, the configuration may include a factor (e.g., a down-sampling factor) and/or a start offset to be used by the second network entity 710 to determine the subset of on durations to be included in the DRX cycle to be used when low-power wakeup signaling is deactivated. As another example, the first DRX cycle information may indicate a first one or more on durations associated with RRM measurement and a second one or more on durations that are not associated with RRM measurement. The configuration information may indicate that a DRX cycle configured via the second DRX cycle information is a DRX cycle that includes the first one or more on durations associated with RRM measurement (e.g., and does not include the second one or more on durations that are not associated with RRM measurement).

In some aspects, the first DRX cycle information and the second DRX cycle information may indicate separate DRX cycle durations or lengths and one or more common DRX parameters (e.g., that are applicable for both active LP-WUS monitoring and deactivated LP-WUS monitoring). For example, a slot offset, an on duration timer, and/or an inactivity timer may be common for both the first DRX cycle information and the second DRX cycle. Additionally, or alternatively, the first DRX cycle information may indicate a first DRX cycle duration or length and a first one or more DRX parameters (e.g., a first duration timer, and/or a first inactivity timer). In such examples, the second DRX cycle information may indicate a second DRX cycle duration or length and a second one or more DRX parameters (e.g., a second duration timer, and/or a second inactivity timer). For example, the second DRX cycle information may indicate longer on durations as compared to the first DRX cycle information (e.g., the second DRX cycle information that indicates less frequent on durations may indicate a longer on durations). This enables more monitoring opportunities for the second network entity 710 when the on durations are configured to occur less frequently over time.

When monitoring in accordance with the first DRX cycle information, the second network entity 710 may monitor the control channel (e.g., via the main radio) during a configured on duration based on, in response to, or otherwise associated with detecting an LP-WUS (e.g., via the LP-WUR) during an LP-WUS monitoring occasion corresponding to that on duration. When monitoring in accordance with the first DRX cycle information, the second network entity 710 may monitor the control channel (e.g., via the main radio) during a configured on duration independent of, or regardless of, whether an LP-WUS is detected (e.g., because LP-WUS monitoring is deactivated).

For example, when the second network entity 710 is physically location near a cell center with good LP-WUS quality, the second network entity 710 may be configured to monitor for LP-WUSs and use the denser DRX pattern with shorter cycles (e.g., the first DRX cycle information). The second network entity 710 may monitor LP-WUS before the start of each on duration and determines whether start the on duration timer based on whether the LP-WUS is detected. By this means, the second network entity 710 may replace a large control channel monitoring power consumption with a small LP-WUS monitoring power consumption (e.g., via the LP-WUR). For bursty traffic, the second network entity 710 may not start the on duration timer in most of the configured DRX cycles in accordance with the first DRX cycle information. This may conserve overall power consumption by the second network entity 710. When the second network entity 710 is physically located near a cell edge where LP-WUS may not be reliably detected, the second network entity 710 may be configured to stop LP-WUS monitoring and switch to the sparser DRX pattern with longer cycles (e.g., in accordance with the second DRX cycle information). This enables the second network entity 710 to save power from excessive control channel monitoring in every DRX cycle. In such examples, the second network entity 710 may fall back from LP-WUS monitoring to PDCCH based WUS monitoring before the start of each on duration.

The second network entity 710 may configure itself based at least in part on the configuration information. In some aspects, the second network entity 710 may be configured to perform one or more operations described herein based at least in part on the configuration information. For example, the second network entity 710 may configure a CSI measurement operation for a given CSI resource to include one or more subbands indicated by a CSI reporting band IE that is associated with the given CSI resource (e.g., as indicated by the CSI configuration information, as described in more detail elsewhere herein).

In some aspects, the configuration information described in connection with reference number 720 and/or the capability information described in connection with reference number 715 may include information transmitted via multiple communications. Additionally, or alternatively, the first network entity 705 may transmit the configuration information, or a communication including at least a portion of the configuration information, before and/or after the second network entity 710 transmits the capability report.

As shown by reference number 725, the second network entity 710 may activate LP-WUS monitoring. The second network entity 710 may determine (e.g., autonomously without receiving instructions or an indication from another device) to activate LP-WUS monitoring. For example, the second network entity 710 may activate LP-WUS monitoring based on, or otherwise associated with, measurement information, such as measurement information obtained via the main radio. For example, the measurement information may indicate CSI or one or more measurements. The second network entity 710 may determine to activate LP-WUS monitoring based on, or otherwise associated with the CSI or one or more measurements. As an example, if the one or more measurements satisfy a threshold (e.g., indicating good signal strength or good signal quality), then the second network entity 710 may activate LP-WUS monitoring. In some aspects, the second network entity 710 may transmit, and the first network entity 705 may receive, an indication that LP-WUS monitoring is active at the second network entity 710. For example, the second network entity 710 may transmit an uplink signal that includes information indicating that LP-WUS monitoring is active at the second network entity 710.

In some aspects, the first network entity 705 may determine whether LP-WUS monitoring is to be performed by the second network entity 710. For example, the second network entity 710 may transmit, and the first network entity 705 may receive, measurement information (e.g., indicating CSI or one or more measurements). For example, the measurement information may be included in a CSI report or an L1-RSRP report, among other examples. The first network entity 705 may determine that LP-WUS monitoring is to be performed by the second network entity 710 based on, or otherwise associated with the CSI or one or more measurements. As an example, if the one or more measurements satisfy a threshold (e.g., indicating good signal strength or good signal quality), then the first network entity 705 may determine that LP-WUS monitoring is to be performed by the second network entity 710. In some aspects, the first network entity 705 may transmit, and the second network entity 710 may receive, an indication that LP-WUS monitoring is to be performed by the second network entity 710. For example, the first network entity 705 may transmit a downlink signal that includes information indicating that LP-WUS monitoring is to be performed by the second network entity 710. The second network entity 710 may activate LP-WUS monitoring based on, in response to, or otherwise associated with receiving the indication from the first network entity 705.

Activating LP-WUS monitoring may include the second network entity 710 monitoring for LP-WUS(s) during one or more configured LP-WUS monitoring occasions using the LP-WUR. Additionally, the second network entity 710 may apply the first DRX cycle information based on, in response to, or otherwise associated with, activating LP-WUS monitoring.

For example, as shown by reference number 730, the second network entity 710 may monitor a control channel (e.g., the PDCCH) in accordance with the first DRX cycle information. Monitoring the control channel in accordance with the first DRX cycle information may include the second network entity 710 using a first DRX cycle length or duration (e.g., a first amount of time between configured on durations). As described elsewhere herein, when LP-WUS monitoring is activated, the second network entity 710 may use a shorter DRX cycle length or duration (e.g., with less time between configured on durations).

The first DRX cycle information may be associated with a first DRX cycle during which on durations are only monitored by the second network entity 710 based on, in response to, or otherwise associated with an LP-WUS detection or reception. For example, if the first network entity 705 has a communication (e.g., a PDCCH communication or another communication) to transmit to the second network entity 710, then the first network entity 705 may transmit, and the second network entity 710 may receive, an LP-WUS (e.g., as shown by reference number 735). The second network entity 710 may detect and/or receive the LP-WUS via the LP-WUR of the second network entity 710. The second network entity 710 may cause the main radio to be powered on or activated based on, in response to, or otherwise associated with detecting or receiving the LP-WUS. The second network entity 710 may monitor the control channel (e.g., the PDCCH) using the main radio in a corresponding on duration (e.g., an on duration that is configured to occur next in time) based on, in response to, or otherwise associated with detecting or receiving the LP-WUS. For example, the second network entity 710 may initiate an on duration timer (e.g., indicated by the first DRX cycle information) based on, in response to, or otherwise associated with detecting or receiving the LP-WUS. As shown by reference number 740, the first network entity 705 may transmit, and the second network entity 710 may receive, a control channel communication (e.g., a PDCCH communication) during the on duration. The second network entity 710 may detect and/or receive the control channel communication via the main radio based on, or otherwise associated with, monitor the control channel (e.g., the PDCCH) using the main radio during the on duration.

Alternatively, if the first network entity 705 does not have a communication (e.g., a control channel communication or another communication) to transmit to the second network entity 710, then the first network entity 705 may refrain from (e.g., may not) transmit the LP-WUS to the second network entity 710. The second network entity 710 may monitor for the LP-WUS during a given LP-WUS monitoring occasion. Because the first network entity 705 does not transmit the LP-WUS, the second network entity 710 may not detect or receive the LP-WUS. Therefore, the second network entity 710 may refrain from (e.g., may not) power on or activate the main radio of the second network entity 710 for a corresponding on duration (e.g., a next occurring on duration after the LP-WUS monitoring occasion) configured by the first DRX cycle information. The second network entity may refrain from (e.g., may not or may skip) monitoring the control channel (e.g., the PDCCH) via the main radio during the corresponding on duration. This conserves power of the second network entity 710 that would have otherwise been associated with the second network entity 710 monitoring the control channel via the main radio when the first network entity 705 does not have a communication to transmit to the second network entity 710.

As shown by reference number 745, the second network entity 710 may deactivate LP-WUS monitoring. The second network entity 710 may determine (e.g., autonomously without receiving instructions or an indication from another device) to deactivate LP-WUS monitoring. For example, the second network entity 710 may deactivate LP-WUS monitoring based on, or otherwise associated with, measurement information, such as measurement information obtained via the main radio or measurement information of LP-WUS(s) obtain via the LP-WUR. For example, the measurement information may indicate CSI or one or more measurements or may indicate one or more measurements of an LP-WUS. The second network entity 710 may determine to deactivate LP-WUS monitoring based on, or otherwise associated with the CSI or one or more measurements. As an example, if the one or more measurements satisfy a threshold (e.g., indicating poor signal strength or poor signal quality of LP-WUS(s) or other signals), then the second network entity 710 may deactivate LP-WUS monitoring (e.g., because this may be indicative of low detection probability by the LP-WUR for transmitted LP-WUSs). In some aspects, the second network entity 710 may transmit, and the first network entity 705 may receive, an indication that LP-WUS monitoring is deactivated at the second network entity 710. For example, the second network entity 710 may transmit an uplink signal that includes information indicating that LP-WUS monitoring is deactivated at the second network entity 710.

In some aspects, the first network entity 705 may determine whether LP-WUS monitoring is to be performed by the second network entity 710. For example, the second network entity 710 may transmit, and the first network entity 705 may receive, measurement information (e.g., indicating CSI or one or more measurements). For example, the measurement information may be included in a CSI report or an L1-RSRP report, among other examples. The first network entity 705 may determine that LP-WUS monitoring is not to be performed by the second network entity 710 based on, or otherwise associated with the CSI or one or more measurements. As an example, if the one or more measurements satisfy a threshold (e.g., indicating good signal strength or good signal quality), then the first network entity 705 may determine that LP-WUS monitoring is not to be performed by the second network entity 710.

As another example, the first network entity 705 may determine that LP-WUS monitoring is (or should be) deactivated at the second network entity 710 based on feedback information. For example, the first network entity 705 may determine that the first network entity 705 has not received acknowledgements (ACKs) (e.g., HARQ-ACKs) for downlink communications that are scheduled via a control communication (e.g., PDCCH communication) for which the first network entity 705 transmitted an LP-WUS to cause the second network entity 710 to monitor for the control communication. Additionally, or alternatively, the first network entity 705 may determine that the first network entity 705 has not received one or more uplink communications that are scheduled via a control communication (e.g., PDCCH communication) for which the first network entity 705 transmitted an LP-WUS to cause the second network entity 710 to monitor for the control communication. This may be indicative of the second network entity 710 not receiving, or not monitoring for, the LP-WUS(s). As a result, the second network entity 710 may determine that LP-WUS monitoring is (or should be) deactivated at the second network entity 710.

In some aspects, the first network entity 705 may transmit, and the second network entity 710 may receive, an indication that LP-WUS monitoring is not to be performed by the second network entity 710. For example, the first network entity 705 may transmit a downlink signal that includes information indicating that LP-WUS monitoring is not to be performed by the second network entity 710. The second network entity 710 may deactivate LP-WUS monitoring based on, in response to, or otherwise associated with receiving the indication from the first network entity 705.

Deactivating LP-WUS monitoring may include the second network entity 710 refraining from (e.g., skipping) monitoring for LP-WUS(s) during one or more configured LP-WUS monitoring occasions using the LP-WUR. Additionally, the second network entity 710 may apply the second DRX cycle information based on, in response to, or otherwise associated with, deactivating LP-WUS monitoring.

For example, as shown by reference number 750, the second network entity 710 may monitor the control channel in accordance with the second DRX cycle information. Monitoring the control channel in accordance with the second DRX cycle information may include the second network entity 710 using a second DRX cycle length or duration (e.g., a first amount of time between configured on durations). As described elsewhere herein, when LP-WUS monitoring is deactivated, the second network entity 710 may use a longer DRX cycle length or duration (e.g., with more time between configured on durations). In some aspects, the second DRX cycle configuration may explicitly configure the on durations to be monitored by the second network entity 710. In other examples, the second network entity 710 may monitor a subset of on durations configured by the first DRX cycle configuration, such as down sampled on durations or on durations configured for RRM measurement, among other examples. For example, when monitoring the control channel in accordance with the second DRX cycle information, the second network entity 710 may skip one or more on durations configured via the configuration information, effectively resulting in a longer DRX cycle length or duration as compared to when the second network entity 710 monitored the control channel as described in connection with reference number 730.

For example, the second network entity 710 may monitor the control channel in accordance with the first DRX cycle information based on the low-power wakeup signal detection being activated at a first time (e.g., as depicted and described in connection with reference number 730). The second network entity 710 may monitor the control channel in accordance with the second DRX cycle information based on the low-power wakeup signal detection being deactivated after (or before) the first time (e.g., as depicted and described in connection with reference number 750).

When monitoring the control channel in accordance with the second DRX cycle information, the second network entity 710 may monitor the control channel during one or more on durations independent of, or regardless of, LP-WUS detection. For example, the second network entity 710 may power on the main radio and monitor the control channel during an on duration independent of, or regardless of, LP-WUS detection. In some aspects, as shown by reference number 755, the first network entity 705 may transmit, and the second network entity 710 may receive, a control channel communication during an on duration indicated by the second DRX cycle information. The second network entity 710 may receive the control channel communication based on, or otherwise associated with, monitoring the control channel during the on duration using the main radio. Because the second network entity 710 may power on the main radio and monitor the control channel during an on duration independent of, or regardless of, LP-WUS detection, causing the DRX cycle length (e.g., the amount of time between consecutive on durations) to be longer when LP-WUS monitoring is deactivated may conserve power of the second network entity 710 as compared to using the shorter DRX cycle length indicated by the first DRX cycle information.

As indicated above, FIG. 7 is provided as an example. Other examples may differ from what is described with respect to FIG. 7.

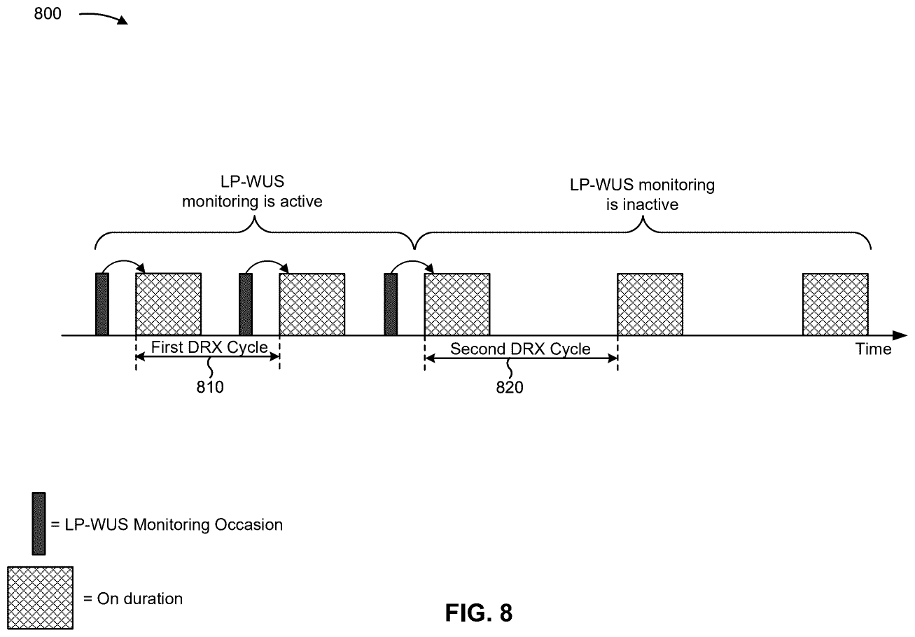

FIG. 8 is a diagram of an example 800 associated with DRX cycles for low-power wakeup signaling, in accordance with the present disclosure. As shown in FIG. 8, during a first time, LP-WUS monitoring is active (or activated) for the second network entity 710. During the first time, the second network entity 710 may be configured to monitor a control channel (e.g., the PDCCH) using a first DRX cycle 810. The first DRX cycle 810 may be associated with a first length or duration (e.g., a first amount of time between configured on durations).

As shown in FIG. 8, the second network entity 710 may monitor for LP-WUS(s) during a configured LP-WUS monitoring occasion prior to each configured on duration. If an LP-WUS is detected in a given LP-WUS monitoring occasion, then the second network entity 710 may power on the main radio and monitor the control channel (e.g., using the main radio) during the next on duration.

As shown in FIG. 8, during a second time, LP-WUS monitoring is inactive (or deactivated) for the second network entity 710. During the second time, the second network entity 710 may monitor a control channel (e.g., the PDCCH) using a second DRX cycle 820. The second DRX cycle 820 may be associated with a second length or duration (e.g., a second amount of time between configured on durations). As shown in FIG. 8, the second length or duration may be longer than the first length or duration (e.g., of the first DRX cycle 810). This results in on durations occurring less frequently over time when LP-WUS monitoring is inactive. As shown in FIG. 8, during the second time, the second network entity 710 may not monitor for an LP-WUS prior to each on duration. Therefore, by causing or configuring the on durations to occur less frequently over time, power of the second network entity 710 may be conserved (e.g., as compared to more frequently monitoring the control channel, such as in accordance with the first DRX cycle 810).

As indicated above, FIG. 8 is provided as an example. Other examples may differ from what is described with respect to FIG. 8.

FIG. 9 is a diagram illustrating an example process 900 performed, for example, at a first network entity or an apparatus of a first network entity, in accordance with the present disclosure. Example process 900 is an example where the apparatus or the first network entity (e.g., second network entity 710, the network entity 102, the network entity 104, the network entity 106, or a UE 220) performs operations associated with DRX cycles for low-power wakeup signaling.

As shown in FIG. 9, in some aspects, process 900 may include receiving, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling (block 910). For example, the first network entity (e.g., using reception component 1102 and/or communication manager 1106, depicted in FIG. 11) may receive, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling, as described above.

As further shown in FIG. 9, in some aspects, process 900 may include monitoring a control channel in accordance with either the first DRX cycle information, based on low-power wakeup signal detection being activated, or the second DRX cycle information, based on low-power wakeup signal detection being deactivated (block 920). For example, the first network entity (e.g., using reception component 1102 and/or communication manager 1106, depicted in FIG. 11) may monitor a control channel in accordance with either the first DRX cycle information, based on low-power wakeup signal detection being activated, or the second DRX cycle information, based on low-power wakeup signal detection being deactivated, as described above.

Process 900 may include additional aspects, such as any single aspect or any combination of aspects described below and/or in connection with one or more other processes described elsewhere herein.

In a first aspect, process 900 includes obtaining an indication of whether low-power wakeup signal detection is activated or deactivated.

In a second aspect, alone or in combination with the first aspect, obtaining the indication of whether low-power wakeup signal detection is activated or deactivated includes determining, based on one or more low-power wakeup signal parameters, whether low-power wakeup signal detection is activated or deactivated.

In a third aspect, alone or in combination with one or more of the first and second aspects, obtaining the indication of whether low-power wakeup signal detection is activated or deactivated includes receiving, from the second network entity, the indication of whether low-power wakeup signal detection is activated or deactivated.

In a fourth aspect, alone or in combination with one or more of the first through third aspects, process 900 includes transmitting, to the second network entity, an indication of whether low-power wakeup signal detection is activated or deactivated.

In a fifth aspect, alone or in combination with one or more of the first through fourth aspects, the second DRX cycle information is based on the first DRX cycle information.

In a sixth aspect, alone or in combination with one or more of the first through fifth aspects, the first DRX cycle information indicates a set of on durations, and the second DRX cycle information indicates a DRX cycle that includes a subset of on durations from the set of on durations.

In a seventh aspect, alone or in combination with one or more of the first through sixth aspects, monitoring the control channel includes skipping, in accordance with the second DRX cycle information, monitoring the control channel during on durations from the set of on durations that are not included in the subset of on durations.

In an eighth aspect, alone or in combination with one or more of the first through seventh aspects, the first DRX cycle information indicates a first one or more on durations associated with radio resource management measurement and a second one or more on durations that are not associated with radio resource management measurement, and the second DRX cycle information indicates a DRX cycle that only includes the first one or more on durations.

In a ninth aspect, alone or in combination with one or more of the first through eighth aspects, monitoring the control channel includes skipping, in accordance with the second DRX cycle information, monitoring the control channel during the second one or more on durations.

In a tenth aspect, alone or in combination with one or more of the first through ninth aspects, the first DRX cycle information indicates a first DRX cycle length, and the second DRX cycle information indicates a second DRX cycle length.

In an eleventh aspect, alone or in combination with one or more of the first through tenth aspects, the first DRX cycle length is shorter than the second DRX cycle length.

In a twelfth aspect, alone or in combination with one or more of the first through eleventh aspects, monitoring the control channel includes monitoring the control channel in accordance with the first DRX cycle information based on the low-power wakeup signal detection being activated at a first time, and process 900 includes monitoring the control channel in accordance with the second DRX cycle information based on the low-power wakeup signal detection being deactivated after the first time.

In a thirteenth aspect, alone or in combination with one or more of the first through twelfth aspects, the first DRX cycle information and the second DRX cycle information are associated with a same one or more DRX parameters.

In a fourteenth aspect, alone or in combination with one or more of the first through thirteenth aspects, the first DRX cycle information is associated with a first one or more DRX parameters, and the second DRX cycle information is associated with a second one or more DRX parameters.

In a fifteenth aspect, alone or in combination with one or more of the first through fourteenth aspects, the first DRX cycle information is associated with a first DRX cycle during which on durations are only monitored based on a low-power wakeup signal detection, and the second DRX cycle information is associated with a second DRX cycle during which on durations are monitored independent of low-power wakeup signal detection.

In a sixteenth aspect, alone or in combination with one or more of the first through fifteenth aspects, the first DRX cycle information and the second DRX cycle information are associated with a connected mode DRX cycle.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a first network entity or an apparatus of a first network entity, in accordance with the present disclosure. Example process 1000 is an example where the apparatus or the first network entity (e.g., first network entity 705, the network entity 102, the network entity 104, the network entity 106, or a network node 210) performs operations associated with DRX cycles for low-power wakeup signaling.

As shown in FIG. 10, in some aspects, process 1000 may include transmitting, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling (block 1010). For example, the first network entity (e.g., using transmission component 1204 and/or communication manager 1206, depicted in FIG. 12) may transmit, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling, as described above.

As further shown in FIG. 10, in some aspects, process 1000 may include transmitting one or more communications in accordance with either the first DRX cycle information, based on low-power wakeup signal detection being activated, or the second DRX cycle information, based on low-power wakeup signal detection being deactivated (block 1020). For example, the first network entity (e.g., using transmission component 1204 and/or communication manager 1206, depicted in FIG. 12) may transmit one or more communications in accordance with either the first DRX cycle information, based on low-power wakeup signal detection being activated, or the second DRX cycle information, based on low-power wakeup signal detection being deactivated, as described above.

Process 1000 may include additional aspects, such as any single aspect or any combination of aspects described below and/or in connection with one or more other processes described elsewhere herein.

In a first aspect, process 1000 includes obtaining an indication of whether low-power wakeup signal detection is activated or deactivated.

In a second aspect, alone or in combination with the first aspect, obtaining the indication of whether low-power wakeup signal detection is activated or deactivated includes determining, based on one or more low-power wakeup signal parameters, whether low-power wakeup signal detection is activated or deactivated.

In a third aspect, alone or in combination with one or more of the first and second aspects, obtaining the indication of whether low-power wakeup signal detection is activated or deactivated includes transmitting, for the second network entity, the indication of whether low-power wakeup signal detection is activated or deactivated.

In a fourth aspect, alone or in combination with one or more of the first through third aspects, process 1000 includes receiving, from the second network entity, an indication of whether low-power wakeup signal detection is activated or deactivated.

In a fifth aspect, alone or in combination with one or more of the first through fourth aspects, the second DRX cycle information is based on the first DRX cycle information.

In a sixth aspect, alone or in combination with one or more of the first through fifth aspects, the first DRX cycle information indicates a set of on durations, and the second DRX cycle information indicates a DRX cycle that includes a subset of on durations from the set of on durations.

In a seventh aspect, alone or in combination with one or more of the first through sixth aspects, process 1000 includes refraining from transmitting, in accordance with the second DRX cycle information, the one or more communications during on durations from the set of on durations that are not included in the subset of on durations.

In an eighth aspect, alone or in combination with one or more of the first through seventh aspects, the first DRX cycle information indicates a first one or more on durations associated with radio resource management measurement and a second one or more on durations that are not associated with radio resource management measurement, and the second DRX cycle information indicates a DRX cycle that only includes the first one or more on durations.

In a ninth aspect, alone or in combination with one or more of the first through eighth aspects, process 1000 includes refraining from transmitting, in accordance with the second DRX cycle information, the one or more communications during the second one or more on durations.

In a tenth aspect, alone or in combination with one or more of the first through ninth aspects, the first DRX cycle information indicates a first DRX cycle length, and the second DRX cycle information indicates a second DRX cycle length.

In an eleventh aspect, alone or in combination with one or more of the first through tenth aspects, the first DRX cycle length is shorter than the second DRX cycle length.

In a twelfth aspect, alone or in combination with one or more of the first through eleventh aspects, the first DRX cycle information and the second DRX cycle information are associated with a same one or more DRX parameters.

In a thirteenth aspect, alone or in combination with one or more of the first through twelfth aspects, the first DRX cycle information is associated with a first one or more DRX parameters, and wherein the second DRX cycle information is associated with a second one or more DRX parameters.

In a fourteenth aspect, alone or in combination with one or more of the first through thirteenth aspects, the first DRX cycle information is associated with a first DRX cycle during which on durations are only monitored based on a low-power wakeup signal detection, and the second DRX cycle information is associated with a second DRX cycle during which on durations are monitored independent of low-power wakeup signal detection.

In a fifteenth aspect, alone or in combination with one or more of the first through fourteenth aspects, the first DRX cycle information and the second DRX cycle information are associated with a connected mode DRX cycle.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network entity, or a network entity may include the apparatus 1100. In some aspects, the network entity may be, or may include, a UE. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 114, the communication manager 118, the communication manager 250, or another communication manager described herein. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 110, the processing system 112, or the processing system 240) of the network entity.

In some aspects, the apparatus 1100 may be configured to perform one or more operations described herein in connection with FIGS. 7 and 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network entity described in connection with FIGS. 1-3. Additionally, or alternatively, one or more components shown in FIG. 11 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network entity described above in connection with FIGS. 1-3, such as a radio, one or more RF chains, one or more transceivers, or one or more modems, each of which may in turn be coupled with one or more antennas of the network entity.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network entity described above in connection with FIGS. 1-3, such as a radio, one or more RF chains, one or more transceivers, or one or more modems, each of which may in turn be coupled with one or more antennas of the network entity described in connection with FIGS. 1-3. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling. The communication manager 1106 may monitor a control channel in accordance with either the first DRX cycle information, based on low-power wakeup signal detection being activated, or the second DRX cycle information, based on low-power wakeup signal detection being deactivated.

The reception component 1102 may obtain an indication of whether low-power wakeup signal detection is activated or deactivated.

The transmission component 1104 may transmit, to the second network entity, an indication of whether low-power wakeup signal detection is activated or deactivated.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network entity, or a network entity may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 114, the communication manager 118, the communication manager 250, or another communication manager described herein. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 110, the processing system 112, or the processing system 245) of the network entity.

In some aspects, the apparatus 1200 may be configured to perform one or more operations described herein in connection with FIGS. 7 and 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network entity described in connection with FIGS. 1-3. Additionally, or alternatively, one or more components shown in FIG. 12 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network entity described above in connection with FIGS. 1-3, such as a radio, one or more RF chains, one or more transceivers, or one or more modems, each of which may in turn be coupled with one or more antennas of the network entity.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network entity described above in connection with FIG. 1, such as a radio, one or more RF chains, one or more transceivers, or one or more modems, each of which may in turn be coupled with one or more antennas of the network entity described in connection with FIGS. 1-3. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, for a second network entity, configuration information indicating first DRX cycle information and second DRX cycle information, wherein the first DRX cycle information is associated with activated low-power wakeup signaling, and wherein the second DRX cycle information is associated with deactivated low-power wakeup signaling. The transmission component 1204 may transmit one or more communications in accordance with either the first DRX cycle information, based on low-power wakeup signal detection being activated, or the second DRX cycle information, based on low-power wakeup signal detection being deactivated.

The reception component 1202 may obtain an indication of whether low-power wakeup signal detection is activated or deactivated.

The reception component 1202 may receive, from the second network entity, an indication of whether low-power wakeup signal detection is activated or deactivated.

The communication manager 1206 may refrain from transmitting, in accordance with the second DRX cycle information, the one or more communications during on durations from the set of on durations that are not included in the subset of on durations.

The communication manager 1206 may refrain from transmitting, in accordance with the second DRX cycle information, the one or more communications during the second one or more on durations.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a first network entity, comprising: receiving, from a second network entity, configuration information indicating first discontinuous reception (DRX) cycle information and second DRX cycle information, wherein the first DRX cycle information is associated with activated low-power wakeup signaling, and wherein the second DRX cycle information is associated with deactivated low-power wakeup signaling; and monitoring a control channel in accordance with either the first DRX cycle information, based on low-power wakeup signal detection being activated, or the second DRX cycle information, based on low-power wakeup signal detection being deactivated.
Aspect 2: The method of Aspect 1, further comprising: obtaining an indication of whether low-power wakeup signal detection is activated or deactivated.
Aspect 3: The method of Aspect 2, wherein obtaining the indication of whether low-power wakeup signal detection is activated or deactivated comprises: determining, based on one or more low-power wakeup signal parameters, whether low-power wakeup signal detection is activated or deactivated.
Aspect 4: The method of any of Aspects 2-3, wherein obtaining the indication of whether low-power wakeup signal detection is activated or deactivated comprises: receiving, from the second network entity, the indication of whether low-power wakeup signal detection is activated or deactivated.
Aspect 5: The method of any of Aspects 1-4, further comprising: transmitting, to the second network entity, an indication of whether low-power wakeup signal detection is activated or deactivated.
Aspect 6: The method of any of Aspects 1-5, wherein the second DRX cycle information is based on the first DRX cycle information.
Aspect 7: The method of Aspect 6, wherein the first DRX cycle information indicates a set of on durations, and wherein the second DRX cycle information indicates a DRX cycle that includes a subset of on durations from the set of on durations.
Aspect 8: The method of Aspect 7, wherein monitoring the control channel comprises: skipping, in accordance with the second DRX cycle information, monitoring the control channel during on durations from the set of on durations that are not included in the subset of on durations.
Aspect 9: The method of any of Aspects 6-8, wherein the first DRX cycle information indicates a first one or more on durations associated with radio resource management measurement and a second one or more on durations that are not associated with radio resource management measurement, and wherein the second DRX cycle information indicates a DRX cycle that only includes the first one or more on durations.
Aspect 10: The method of Aspect 9, wherein monitoring the control channel comprises: skipping, in accordance with the second DRX cycle information, monitoring the control channel during the second one or more on durations.
Aspect 11: The method of any of Aspects 1-10, wherein the first DRX cycle information indicates a first DRX cycle length, and wherein the second DRX cycle information indicates a second DRX cycle length.
Aspect 12: The method of Aspect 11, wherein the first DRX cycle length is shorter than the second DRX cycle length.
Aspect 13: The method of any of Aspects 1-12, wherein monitoring the control channel comprises: monitoring the control channel in accordance with the first DRX cycle information based on the low-power wakeup signal detection being activated at a first time, and the method further comprising: monitoring the control channel in accordance with the second DRX cycle information based on the low-power wakeup signal detection being deactivated after the first time.
Aspect 14: The method of any of Aspects 1-13, wherein the first DRX cycle information and the second DRX cycle information are associated with a same one or more DRX parameters.
Aspect 15: The method of any of Aspects 1-14, wherein the first DRX cycle information is associated with a first one or more DRX parameters, and wherein the second DRX cycle information is associated with a second one or more DRX parameters.
Aspect 16: The method of any of Aspects 1-15, wherein the first DRX cycle information is associated with a first DRX cycle during which on durations are only monitored based on a low-power wakeup signal detection, and wherein the second DRX cycle information is associated with a second DRX cycle during which on durations are monitored independent of low-power wakeup signal detection.
Aspect 17: The method of any of Aspects 1-16, wherein the first DRX cycle information and the second DRX cycle information are associated with a connected mode DRX cycle.
Aspect 18: A method of wireless communication performed by a first network entity, comprising: transmitting, for a second network entity, configuration information indicating first discontinuous reception (DRX) cycle information and second DRX cycle information, wherein the first DRX cycle information is associated with activated low-power wakeup signaling, and wherein the second DRX cycle information is associated with deactivated low-power wakeup signaling; and transmitting one or more communications in accordance with either the first DRX cycle information, based on low-power wakeup signal detection being activated, or the second DRX cycle information, based on low-power wakeup signal detection being deactivated.
Aspect 19: The method of Aspect 18, further comprising: obtaining an indication of whether low-power wakeup signal detection is activated or deactivated.
Aspect 20: The method of Aspect 19, wherein obtaining the indication of whether low-power wakeup signal detection is activated or deactivated comprises: determining, based on one or more low-power wakeup signal parameters, whether low-power wakeup signal detection is activated or deactivated.
Aspect 21: The method of any of Aspects 19-20, wherein obtaining the indication of whether low-power wakeup signal detection is activated or deactivated comprises: transmitting, for the second network entity, the indication of whether low-power wakeup signal detection is activated or deactivated.
Aspect 22: The method of any of Aspects 18-21, further comprising: receiving, from the second network entity, an indication of whether low-power wakeup signal detection is activated or deactivated.
Aspect 23: The method of any of Aspects 18-22, wherein the second DRX cycle information is based on the first DRX cycle information.
Aspect 24: The method of Aspect 23, wherein the first DRX cycle information indicates a set of on durations, and wherein the second DRX cycle information indicates a DRX cycle that includes a subset of on durations from the set of on durations.
Aspect 25: The method of Aspect 24, further comprising: refraining from transmitting, in accordance with the second DRX cycle information, the one or more communications during on durations from the set of on durations that are not included in the subset of on durations.
Aspect 26: The method of any of Aspects 23-25, wherein the first DRX cycle information indicates a first one or more on durations associated with radio resource management measurement and a second one or more on durations that are not associated with radio resource management measurement, and wherein the second DRX cycle information indicates a DRX cycle that only includes the first one or more on durations.
Aspect 27: The method of Aspect 26, further comprising: refraining from transmitting, in accordance with the second DRX cycle information, the one or more communications during the second one or more on durations.
Aspect 28: The method of any of Aspects 18-27, wherein the first DRX cycle information indicates a first DRX cycle length, and wherein the second DRX cycle information indicates a second DRX cycle length.
Aspect 29: The method of Aspect 28, wherein the first DRX cycle length is shorter than the second DRX cycle length.
Aspect 30: The method of any of Aspects 18-29, wherein the first DRX cycle information and the second DRX cycle information are associated with a same one or more DRX parameters.
Aspect 31: The method of any of Aspects 18-30, wherein the first DRX cycle information is associated with a first one or more DRX parameters, and wherein the second DRX cycle information is associated with a second one or more DRX parameters.
Aspect 32: The method of any of Aspects 18-31, wherein the first DRX cycle information is associated with a first DRX cycle during which on durations are only monitored based on a low-power wakeup signal detection, and wherein the second DRX cycle information is associated with a second DRX cycle during which on durations are monitored independent of low-power wakeup signal detection.
Aspect 33: The method of any of Aspects 18-32, wherein the first DRX cycle information and the second DRX cycle information are associated with a connected mode DRX cycle.
Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.
Aspect 35: An apparatus for wireless communication at a device, the apparatus comprising one or more memories and one or more processors coupled to the one or more memories, the one or more processors configured to cause the device to perform the method of one or more of Aspects 1-33.
Aspect 36: An apparatus for wireless communication, the apparatus comprising at least one means for performing the method of one or more of Aspects 1-33.
Aspect 37: A non-transitory computer-readable medium storing code for wireless communication, the code comprising instructions executable by one or more processors to perform the method of one or more of Aspects 1-33.
Aspect 38: A non-transitory computer-readable medium storing a set of instructions for wireless communication, the set of instructions comprising one or more instructions that, when executed by one or more processors of a device, cause the device to perform the method of one or more of Aspects 1-33.
Aspect 37: A non-transitory computer-readable medium having code thereon that, when executed by a device, causes the device to perform the method of one or more of Aspects 1-33.
Aspect 39: A device comprising a processing system configured to perform the method of one or more of Aspects 1-33.
Aspect 40: An apparatus for wireless communication at a device, the apparatus comprising one or more memories and one or more processors coupled to the one or more memories, the one or more processors individually or collectively configured to cause the device to perform the method of one or more of Aspects 1-33.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (for example, a+a, a+a+a, a+a+b, a+a+c, a+b+b, a+c+c, b+b, b+b +b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Additionally, as used herein, the phrase “based on” shall not be construed as a reference to a closed set of information, one or more conditions, one or more factors, or the like. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system, configured to:
receive, from a second network entity, configuration information indicating first discontinuous reception (DRX) cycle information and second DRX cycle information, wherein the first DRX cycle information is associated with activated low-power wakeup signaling, and wherein the second DRX cycle information is associated with deactivated low-power wakeup signaling; and
monitor a control channel in accordance with either the first DRX cycle information, based on low-power wakeup signal detection being activated, or the second DRX cycle information, based on low-power wakeup signal detection being deactivated.

2. The first network entity of claim 1, wherein the processing system is configured to:
obtain an indication of whether low-power wakeup signal detection is activated or deactivated.

3. The first network entity of claim 2, wherein the processing system, to obtain the indication of whether low-power wakeup signal detection is activated or deactivated, is configured to:
determine, based on one or more low-power wakeup signal parameters, whether low-power wakeup signal detection is activated or deactivated.

4. The first network entity of claim 2, wherein the processing system, to obtain the indication of whether low-power wakeup signal detection is activated or deactivated, is configured to:
receive, from the second network entity, the indication of whether low-power wakeup signal detection is activated or deactivated.

5. The first network entity of claim 1, wherein the processing system is configured to:
transmit, to the second network entity, an indication of whether low-power wakeup signal detection is activated or deactivated.

6. The first network entity of claim 1, wherein the second DRX cycle information is based on the first DRX cycle information.

7. The first network entity of claim 6, wherein the first DRX cycle information indicates a set of on durations, and wherein the second DRX cycle information indicates a DRX cycle that includes a subset of on durations from the set of on durations.

8. The first network entity of claim 7, wherein the processing system, to monitor the control channel, is configured to:
skip, in accordance with the second DRX cycle information, monitoring the control channel during on durations from the set of on durations that are not included in the subset of on durations.

9. The first network entity of claim 6, wherein the first DRX cycle information indicates a first one or more on durations associated with radio resource management measurement and a second one or more on durations that are not associated with radio resource management measurement, and wherein the second DRX cycle information indicates a DRX cycle that only includes the first one or more on durations.

10. The first network entity of claim 9, wherein the processing system, to monitor the control channel, is configured to:
skip, in accordance with the second DRX cycle information, monitoring the control channel during the second one or more on durations.

11. The first network entity of claim 1, wherein the first DRX cycle information indicates a first DRX cycle length, and wherein the second DRX cycle information indicates a second DRX cycle length.

12. The first network entity of claim 11, wherein the first DRX cycle length is shorter than the second DRX cycle length.

13. The first network entity of claim 1, wherein the processing system, to monitor the control channel, is configured to:
monitor the control channel in accordance with the first DRX cycle information based on the low-power wakeup signal detection being activated at a first time, and
wherein the processing system is configured to:
monitor the control channel in accordance with the second DRX cycle information based on the low-power wakeup signal detection being deactivated after the first time.

14. The first network entity of claim 1, wherein the first DRX cycle information and the second DRX cycle information are associated with a same one or more DRX parameters.

15. The first network entity of claim 1, wherein the first DRX cycle information is associated with a first one or more DRX parameters, and wherein the second DRX cycle information is associated with a second one or more DRX parameters.

16. The first network entity of claim 1, wherein the first DRX cycle information is associated with a first DRX cycle during which on durations are only monitored based on a low-power wakeup signal detection, and wherein the second DRX cycle information is associated with a second DRX cycle during which on durations are monitored independent of low-power wakeup signal detection.

17. The first network entity of claim 1, wherein the first DRX cycle information and the second DRX cycle information are associated with a connected mode DRX cycle.

18. A method of wireless communication performed by a first network entity, comprising:
receiving, from a second network entity, configuration information indicating first discontinuous reception (DRX) cycle information and second DRX cycle information, wherein the first DRX cycle information is associated with activated low-power wakeup signaling, and wherein the second DRX cycle information is associated with deactivated low-power wakeup signaling; and
monitoring a control channel in accordance with either the first DRX cycle information, based on low-power wakeup signal detection being activated, or the second DRX cycle information, based on low-power wakeup signal detection being deactivated.

19. The method of claim 18, wherein monitoring the control channel comprises:
monitoring the control channel in accordance with the first DRX cycle information based on the low-power wakeup signal detection being activated at a first time, and the method further comprising:
monitoring the control channel in accordance with the second DRX cycle information based on the low-power wakeup signal detection being deactivated after the first time.

20. A non-transitory computer-readable medium having code thereon that, when executed by one or more processors of a first network entity, cause the first network entity to:
receive, from a second network entity, configuration information indicating first discontinuous reception (DRX) cycle information and second DRX cycle information, wherein the first DRX cycle information is associated with activated low-power wakeup signaling, and wherein the second DRX cycle information is associated with deactivated low-power wakeup signaling; and
monitor a control channel in accordance with either the first DRX cycle information, based on low-power wakeup signal detection being activated, or the second DRX cycle information, based on low-power wakeup signal detection being deactivated.
